(19) United States
(12) Patent Application Publication
(10) Pub. No.: US 2009/0110869 A1
(43) Pub. Date: Apr. 30, 2009

(54) POLYURETHANE BACKED PRODUCTS AND METHODS

(76) Inventors: Amy B. Streeton, LaGrange, GA (US); Robin R. Beistline, LaGrange, GA (US); Julie A.O. Smallfield, Woodfuff, SC (US); Dennis L. Riddle, LaGrange, GA (US); N. David Sellman, JR., LaGrange, GA (US); Kenneth B. Higgins, LaGrange, GA (US)

Correspondence Address: Legal Department (M-495), P.O. Box 1926, Spartanburg, SC, 29304, US

(21) Appl. No.: 11/930,408

(22) Filed: Oct. 31, 2007

(51) Int. Cl. B32B 33/00; C08L 75/04

(52) U.S. Cl. 428/90; 428/95; 524/590

(57) ABSTRACT

A surface covering such as a carpet, carpet tile, area rug, floor mat or the like incorporating a textile face disposed in contacting overlying relation to at least one polyurethane layer. One or more optional intermediate structure layers may be disposed within, on, over, or under the polyurethane layer and one or more optional backing layers may be disposed across the underside of the polyurethane layer. Polyurethane compositions preferably including castor oil may form the precoat, tiecoat, and/or backing.

### TECHNICAL FIELD

In accordance with at least one embodiment, the present invention relates to surface coverings such as floor coverings having a show surface material in contacting overlying relation to a backing of polyurethane with or without additional structures, layers, backings, and/or the like. In particular, but not exclusively, at least one embodiment of the invention relates to a surface covering such as a carpet, carpet tile, area rug, floor mat or the like incorporating a textile face, such as a tufted, bonded, flocked, needled, needle punched, woven, non-woven, or knit fabric structure disposed in contacting overlying relation to at least a polyurethane layer. The polyurethane layer may form a precoat, tiecoat and/or backing and may be foam or non-foam, and may preferably be flexible. One or more optional intermediate structure layers may be disposed over, in, on, or under the polyurethane and one or more optional backing layers may be disposed across the underside of the polyurethane. Methods of making such surface coverings, processes, uses, apparatus, components, materials, and/or products are also provided.

### BACKGROUND OF THE INVENTION

It is known to provide carpeting and carpet tile with, for example, tufted or bonded carpet faces, and with backing layers formed from so-called “virgin” or “filled” foam, for example, polyurethane foam, or from “rebond” or “bonded” foam wherein chips or pieces of recycled foam are held together by a binder. It is also known to form mats such as floor mats or entry way mats from tufted or bonded carpet faces secured in bonded relation to rubber backings.

One disadvantage of prior flooring or floor covering constructions has been the relatively complex arrangement of various structural layers to provide dimensional stability and wear performance of the products. In this regard, various prior constructions have relied on the inclusion of various adhesive layers, stabilizing layers, and/or on the use of relatively high strength backing layers such as PVC or vulcanized rubber to provide a structure that remains flat across a floor or sub-floor without deforming over time.

Examples of prior carpet tile constructions are described, for example, in U.S. Pat. Nos. 4,522,857; 5,545,276; 5,948,500; 6,203,881; and 6,468,623 each of which are hereby incorporated by reference herein.

Examples of prior floor mats are described in, for example, U.S. Pat. Nos. 6,296,919; 6,478,995; and RE38,422 each of which are hereby incorporated by reference herein.

### SUMMARY OF THE INVENTION

At least one embodiment of the present invention provides advantages and/or alternatives over the prior art by providing a surface covering such as a carpet, carpet tile, area rug, floor mat, flooring, floor tile, rug, mat, broadloom carpet, stabilized broadloom, roll goods, modular flooring, 6-foot broadloom or the like incorporating a textile face, such as a tufted, bonded, flocked, needled, needle punched, woven, non-woven, or knit fabric structure disposed in contacting overlying relation to at least one polyurethane layer. One or more optional intermediate structure layers may be disposed over, in, on, or under the polyurethane and one or more optional backing layers may be disposed across the underside of the polyurethane.

According to a potentially preferred feature, the polyurethane is in direct contacting relation with the underside of the textile face structure without the need for any intermediate binder or pre-coat.

According to another potentially preferred feature, the textile face structure is preferably substantially relaxed such as by steaming, dyeing or the like prior to application of the polyurethane so as to substantially avoid subsequent deformation due to shrinkage.

According to another possibly preferred feature, a polyurethane material or layer is the reaction product of castor oil, an isocyanate and an optional catalyst, an optional filler, and an optional additional polyol.

According to still yet another possibly preferred feature, a polyurethane material or layer is the reaction product of a chemically unmodified castor oil (preferably filtered and dried), an isocyanate, a filler (preferably at least 42% by weight filler), and an optional catalyst, an optional additional polyol, or both.

According to still another potentially preferred feature, a cured flexible polyurethane material is the reaction product of
(i) a polyol component in which castor oil is the predominant reactive polyol; and
(ii) an isocyanate component,
   and the polyurethane material further comprising a filler, the filler being at least 42% by weight of the polyurethane material.

According to still another potentially preferred feature, a cured flexible polyurethane material, is the reaction product of
(i) a polyol component; and
(ii) an isocyanate component,
   and the polyurethane material further comprising a filler, the filler being at least 42% by weight of the polyurethane material, and the cured flexible material being formed substantially in the absence of catalyst.

According to still another potentially preferred feature, a cured flexible polyurethane material, is the reaction product of
(i) a polyol component; and
(ii) an isocyanate component,
   and the polyurethane material further comprising a filler, the filler being at least 42% by weight of the polyurethane material, and the cured flexible material being formed substantially in the absence of a surfactant or a wetting agent.

According to yet another possibly preferred feature, a carpet tile has a textile face structure disposed in overlying contacting relation to at least one layer of flexible, polyurethane backing composition, the polyurethane composition being the reaction product of
(i) a polyol component in which castor oil is the predominant reactive polyol; and
(ii) an isocyanate component,
   and the polyurethane composition further comprising a filler, the filler being at least 42% by weight of the polyurethane composition and being preferably selected from coal fly ash, recycled gypsum, recycled glass, and combinations thereof.

The feature above, wherein substantially the entire polyol component is castor oil, wherein the polyurethane composition is substantially free of surfactant, wherein the polyurethane composition is substantially free of catalyst, wherein said layer of flexible, polyurethane backing composition is at least one of a precoat, tiecoat, and backing, further comprising at least one structural support layer disposed in, on, under, or over said layer of flexible, polyurethane backing composition, wherein the filler component is at least 50% by weight of the polyurethane composition, further comprising a minor polyol component which is not castor oil, wherein the minor polyol component is selected from the group consisting of petroleum based polyols, natural polyols, polyols with functionality of 2 or 3 and a molecular weight of about 750 to about 7500, polypropylene glycol (PPG) polyols, polyethylene glycol (PEG) polyols, PPG-PEG copolymer polyols, and combinations thereof, wherein the minor polyol component is present in an amount of less than about 50% by weight of the polyol component of the polyurethane composition, wherein the minor polyol component is present in an amount of less than about 10% by weight of the polyurethane composition, wherein the minor polyol component is present in an amount of less than about 7% by weight of the polyurethane composition, and/or wherein the minor polyol component is present in an amount of less than about 5% by weight of the polyurethane composition.

According to still yet another potentially preferred feature, a polyurethane for application to a woven, non-woven, or tufted textile face structure, including a polyol component, an isocyanate component, a catalyst and other agents, fillers, additives, and the like wherein the catalyst is eliminated, the polyol is replaced with castor oil, or both.

According to still another potentially preferred feature, a common formation unit and process may be used to produce carpet, area rugs, carpet tile, floor mats, and the like.

Other features and further scope of the applicability of the present invention will become apparent from the detailed description to follow, taken in conjunction with the accompanying drawings wherein like parts are designated by like reference numerals in the various views.

### BRIEF DESCRIPTION OF THE DRAWINGS

The invention will now be further described by way of example only and with reference to the drawings, which are briefly described as follows:

FIG. 1 is schematic view illustrating apparatus and process for forming various polyurethane-backed surface coverings.

FIG. 2 is a cross-sectional illustration of an exemplary polyurethane-backed surface covering incorporating a tufted face structure;

FIG. 3 is a cross-sectional illustration of an exemplary polyurethane-backed surface covering incorporating a woven face structure;

FIG. 4 is a cross-sectional illustration of an exemplary polyurethane-backed surface covering incorporating a non-woven face structure;

FIG. 5 is a cross-sectional illustration of an exemplary polyurethane-backed surface covering incorporating a bonded pile face structure;

FIG. 6 is schematic view illustrating apparatus and process for forming various surface coverings incorporating backed polyurethane;

FIG. 7 is a cross-sectional illustration of an exemplary surface covering incorporating a tufted face structure in contacting relation to a backed polyurethane layer;

FIG. 8 is a cross-sectional illustration of an exemplary surface covering incorporating a woven face structure in contacting relation to a backed polyurethane layer;

FIG. 9 is a cross-sectional illustrational of an exemplary surface covering incorporating a non-woven face structure in contacting relation to a backed polyurethane layer;

FIG. 10 is a cross-sectional illustration of an exemplary surface covering incorporating a bonded pile face structure in contacting relation to a backed polyurethane layer;

FIG. 11 is schematic view illustrating apparatus and process for forming various surface coverings incorporating stabilized polyurethane;

FIG. 12 is a cross-sectional illustration of an exemplary surface covering incorporating a tufted face structure in contacting relation to a stabilized polyurethane layer;

FIG. 13 is a cross-sectional illustration of an exemplary surface covering incorporating a woven face structure in contacting relation to a stabilized polyurethane layer;

FIG. 14 is a cross-sectional illustration of an exemplary surface covering incorporating a non-woven face structure in contacting relation to a stabilized polyurethane layer;

FIG. 15 is a cross-sectional illustration of an exemplary surface covering incorporating a bonded pile face structure in contacting relation to a stabilized polyurethane layer;

FIG. 16 is schematic view illustrating apparatus and process for forming various surface coverings incorporating stabilized and backed polyurethane;

FIG. 17 is a cross-sectional illustration of an exemplary surface covering incorporating a tufted face structure in contacting relation to a stabilized and backed polyurethane backing;

FIG. 18 is a cross-sectional illustration of an exemplary surface covering incorporating a woven face structure in contacting relation to a stabilized and backed polyurethane backing;

FIG. 19 is a cross-sectional illustration of an exemplary surface covering incorporating a non-woven face structure in contacting relation to a stabilized and backed polyurethane backing; and

FIG. 20 is a cross-sectional illustration of an exemplary surface covering incorporating a bonded pile face structure in contacting relation to a stabilized and backed polyurethane backing;

FIG. 21 is a cross-sectional illustration of an exemplary surface covering like that of FIG. 2 with the addition of a backing such as a coating, film, or the like;

FIG. 22 is a cross-sectional illustration of an exemplary surface covering like that of FIG. 7 with the addition of a backing such as a coating, film, or the like;

FIG. 23 is a cross-sectional illustration of an exemplary surface-covering like that of FIG. 12 except that the stabilizing layer or material is adjacent or abutting the tufts;

FIG. 24 is a cross-sectional illustration of an exemplary surface covering like that of FIG. 13 except that the stabilizing layer or material is near or on the bottom of the polyurethane backing;

FIG. 25 is a cross-sectional illustration of an exemplary surface covering like that of FIG. 3 except that it is inverted as constructed using an exemplary apparatus and process as shown in FIG. 27;

FIG. 26 is a cross-sectional illustration of an exemplary surface covering like that of FIG. 8 except that it is inverted like in FIGS. 25 and 27; and,

FIG. 27 is a schematic illustration of an exemplary apparatus and process for forming polyurethane backed surface coverings in accordance with another embodiment of the present invention.

### DETAILED DESCRIPTION

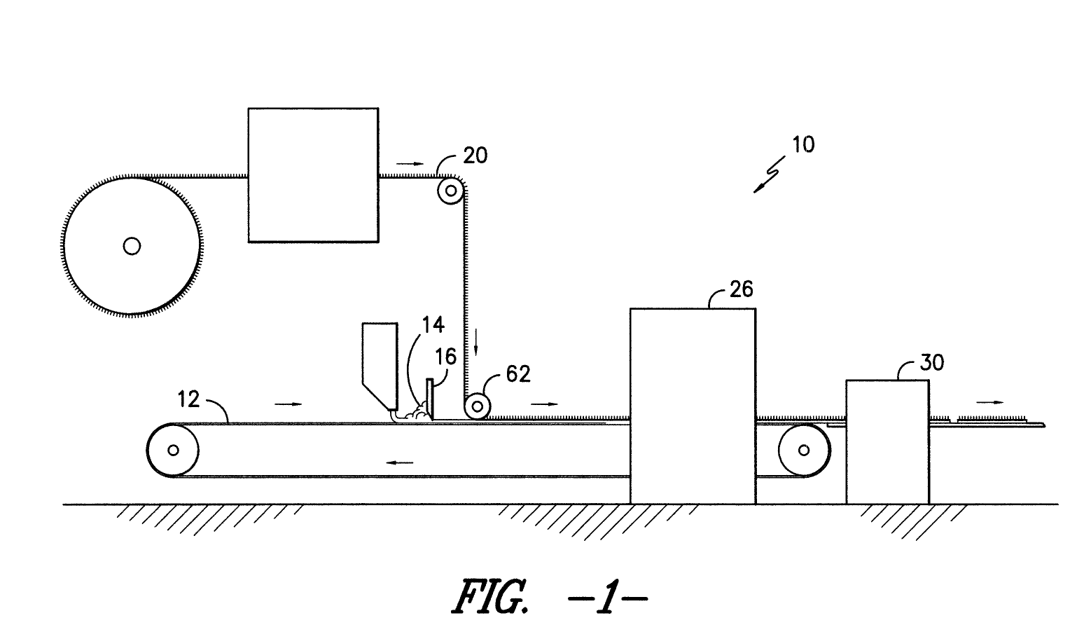

Referring to FIG. 1 of the drawings, an exemplary formation system 10 is illustrated for use in the production of surface coverings or polyurethane backed products such as carpeting, carpet tile, area rugs, roll goods, and/or floor mats. According to the illustrated and potentially preferred embodiment, the formation system 10 includes an endless belt 12 formed from a material such as PTFE woven fiberglass or the like. As shown according to the illustrated process, a mass of uncured polyurethane composition 14 is preferably deposited directly onto the belt 12 and then adjusted to a desired height by a leveler 16 such as a doctor blade, air knife, or the like. The thickness of the leveled polyurethane composition is preferably in the range of about 0.10 inches to about 1.0 inches, more preferably about 0.16 inches to about 0.60 inches although higher or lower thickness levels may likewise be used. While direct application of the polyurethane composition onto the belt 12 may be preferred, it is likewise contemplated that a release layer, film, paper or the like (not shown) on or over the belt or other deposit surface may likewise be used if desired.

By way of example only, one contemplated polyurethane composition is believed to be disclosed in U.S. Pat. No. 5,104,693 to Jenkines, the teachings of which are incorporated herein by reference in their entirety. Fillers, agents, additives, extenders, and the like such as calcium carbonate, coal fly ash, sand, foundry sand, used foundry sand, crushed glass, crushed recycled glass, post-consumer recycled glass, soda lime glass, post-consumer recycled soda lime glass, glass particles, glass fibers, bone, bone meal, metal, recycled metal, iron, steel, ferrite, magnetite, iron oxides, barite, nickel, recycled soda lime glass having a pH in deionized water of greater than 8.4, fillers with a specific gravity (SG) greater than 2, fillers with a specific gravity greater than 5, inert oil, rubber, recycled rubber, SBR particles, mixed fines glass, mixed course glass, crushed bone meal, crushed gypsum, barium sulphate, castor oil, foam chips, recycled carpet tile, natural and/or synthetic fibers, colorants, anti-microbial agents, flame retardants, blowing agents, catalyst, water, recycled materials, renewable materials, bio-based materials, post-consumer recycled materials, post-industrial recycled materials, blends, combinations thereof, and/or the like. Fillers may be added at amounts of about 0.0% to about 99% by weight, most preferably about 10% to about 90% by weight, and more preferably from about 20% to about 80% by weight. Fillers, agents, additives, extenders, liquids, and/or the like may be added in combination with air (or other gases) mixing or frothing and/or blowing to provide density levels as desired. In accordance with at least one particular example, a polyurethane froth density of about 887 grams per litre has been found to provide good results.

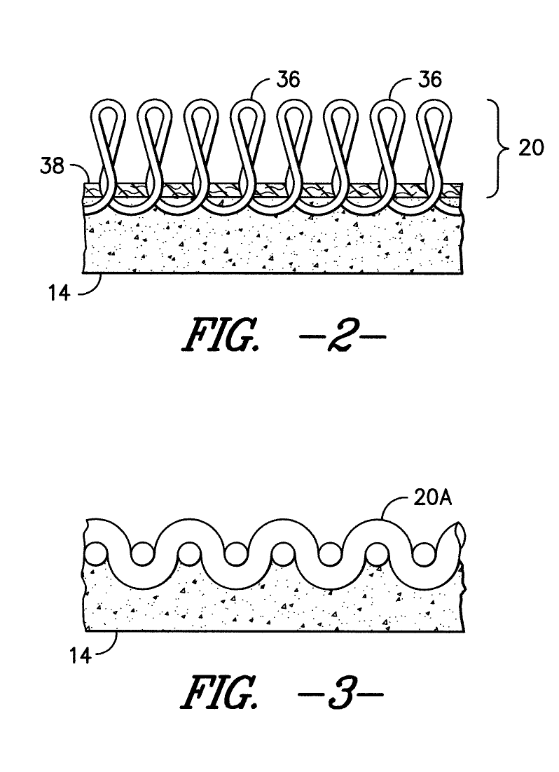

In accordance with one example of an indoor/outdoor polyurethane backed area rug having a construction like that of FIG. 2 of the drawings, a preferred polyurethane backing which serves as precoat and backing (combined precoat/backing) is a mechanically frothed methyl diphenyl diisocyanate (MDI) based polyurethane having an about 750 gram cup weight and an about 27 oz/yd² add on.

Potentially preferred filler examples include (% by weight of the polyurethane):

Used foundry sand (UFS)—50% to 80% by weight

Crushed glass—65% by weight

Calcium carbonate—50% to 65% by weight

Coal fly ash—50% by weight

Blend of used foundry sand (UFS) and calcium carbonate—% by weight
13% UFS and 44% calcium carbonate
21% UFS and 40% calcium carbonate
26% UFS and 37% calcium carbonate

Blend of calcium carbonate and 40 mesh ground tires (SBR)—% by weight

55% calcium carbonate and 10% SBR

Blend of used foundry sand (UFS) and 40 mesh SBR rubber particles (% by weight)
60% UFS and 10% SBR
51% UFS and 13% SBR
47% UFS and 12% SBR

Used foundry sand
42%
72%

Crushed glass
72%

Blend of crushed glass with coal fly ash (CFA)
24% crushed glass and 48% CFA

Blend of crushed glass with calcium carbonate
24% crushed glass and 48% calcium carbonate

Blend of crushed glass with used foundry sand (UFS)
24% crushed glass and 48% UFS

Calcium carbonate
42%
72%

40 mesh SBR
38%
31%
36%

Coal fly ash
42%
69%
72%
75%

Magnetite
76%

Ground bone meal, 30-80%

Ground gypsum, 30-80%

Barium sulphate, 30-80%

Blend of 80×325 mesh mixed course (MC) glass and calcium carbonate

Blend of 80×325 mesh mixed course (MC) glass and used foundry sand

Blend of 100×325 mesh mixed fines (MF) glass and coal fly ash

Blends by grams or parts:
16 g glass 100×325 mesh mixed fines (MF) glass
49 g coal fly ash (CFA) PV 20A
8 g glass 100×325 mesh mixed fines (MF) glass
8 g glass 80×325 mesh mixed course (MC) glass
49 g coal fly ash (CFA)
16 g glass 80×325 mesh mixed course (MC) glass
49 g coal fly ash (CFA)
16 g glass 80×325 mesh mixed course (MC) glass
49 g calcium carbonate
65 g coal fly ash (CFA)
16 g glass 80×325 mesh mixed course (MC) glass
49 g used foundry sand
32.5 g bone
65 g bone
65 g 40 mesh gypsum from recycled drywall
30 g gypsum wet with 15 g water
16 g glass 100×325 mesh mixed fines (MF) glass
49 g calcium carbonate
16 g glass 100×325 mesh mixed fines (MF) glass
49 g used foundry sand

As illustrated, once the polyurethane composition 14 is set to a desired level, a textile face structure 20 with a fibrous underside is preferably delivered into direct contacting relation with the polyurethane composition. For polyurethane backed products such as carpet, area rugs and mats, preferably no intermediate layer is disposed between the polyurethane and the underside of the textile face structure (see FIGS. 2-5). According to one contemplated practice, the textile face structure 20 may be pre-treated at a steam box 22 to relieve internal stresses by application of moisture and heat, may be dyed, may be range dyed, or the like. Such treatment permits the face structure 20 to remain substantially tensionless during subsequent curing of the polyurethane composition 14 as will be described further hereinafter. The elimination of tension in the face structure 20 facilitates the avoidance of undue levels of cupping or curling in the final structure. It is preferred that the polyurethane backing be relatively thin, dense, and flexible and that the face material or fabric be substantially tensionless. Such a product lies flat on the floor, can be bent or rolled, and the like.

Following introduction of the textile face structure 20 across the polyurethane composition 14, the resulting composite structure may thereafter be moved through, for example, an elevated temperature curing range 26. The temperature in the curing range is set to provide substantially complete curing of the polyurethane composition 14. By way of example only and not limitation, such a curing range 26 having, for example, heated platens below belt 12, a platen temperature setting of about 250 degrees F. in a first zone, and with a setting of about 290 degrees F. in subsequent zones has been found to provide good curing results when the belt 12 is operating at a rate of about 30 feet per minute. Of course, these setting may be readily adjusted as desired. For example, certain polyurethane backings may cure at room temperature.

As shown, upon exiting the curing range 26, the composite structure with cured polyurethane may thereafter be removed from the belt 12 and sent to a cutter 30 for segmentation to a length and width as desired based on the final intended use or rolled to be cut later. Cutter 30 may be a clicker for carpet tiles, a cut table for mats or rugs, a slitter, ultrasonic cutter, or the like. Accordingly, the formation system 10 may be used to form carpet, carpet tile, area rugs, roll goods, and/or floor mats as may be desired. In this regard, it is to be understood that the density and thickness levels of polyurethane may be adjusted depending upon the product being produced. Specifically, it is contemplated that the mass per unit area of polyurethane may be slightly higher for carpeting than for floor mats. By way of example only, it has been found that a polyurethane mass per unit area of about 26 to 28 ounces per square yard with a thickness of about 63 mils may be suitable for carpeting while a mass per unit area of about 25 ounces per square yard with a thickness of about 100 mils may be more suitable for dust control mats.

As previously noted, the textile face structure 20 may have any number of suitable constructions. By way of example only, FIGS. 2-5 illustrate a number of polyurethane-backed constructions such as may be formed on the system 10 using various face structures.

FIG. 2 illustrates a tufted textile face structure 20 incorporating an arrangement of yarn elements 36 tufted through a so called “primary backing” 38 such as a woven material, a scrim, a non-woven material, combined woven and non-woven material, or the like. As shown, the cured polyurethane composition 14 extends substantially to the primary backing 38 thereby aiding in locking the yarn elements 36 in place. Although a loop pile is shown, the pile may be loop, cut, or cut and loop.

FIG. 3 illustrates a woven textile face structure 20A disposed in contacting relation to the cured polyurethane composition 14. As shown, the cured polyurethane composition 14 extends substantially to the surface of the woven textile face structure 20A and preferably migrates at least partially into the interstices between yarn elements forming the woven textile face structure 20A to promote good adhesion.

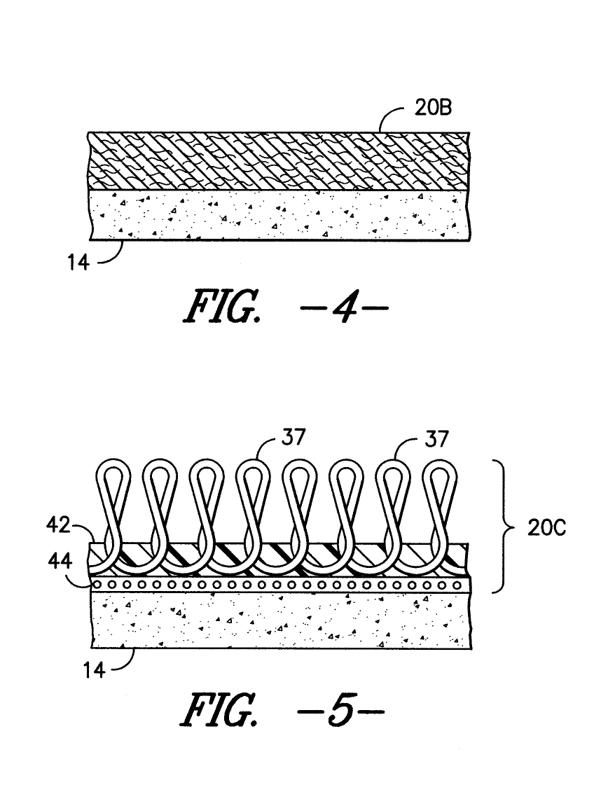

FIG. 4 illustrates a non-woven textile face structure 20B such as a needlepunched, flocked, spunbond, wet laid, or other non-woven construction disposed in contacting relation to the cured polyurethane composition 14. As shown, the cured polyurethane composition 14 extends substantially to the surface of the non-woven textile face structure 20B and preferably migrates at least partially into the interstices between fiber elements forming the non-woven textile face structure 20B to promote good adhesion.

FIG. 5 illustrates a bonded yarn textile face structure 20C incorporating an arrangement of yarn or pile elements 37 bonded in place across a primary backing or substrate layer 44 by an adhesive 42 disposed across at least the upper surface of the primary backing layer 44. Although a loop pile is shown, the pile may be loop, cut, or cut and loop. As shown, the cured polyurethane composition 14 preferably extends substantially to the primary backing 44.

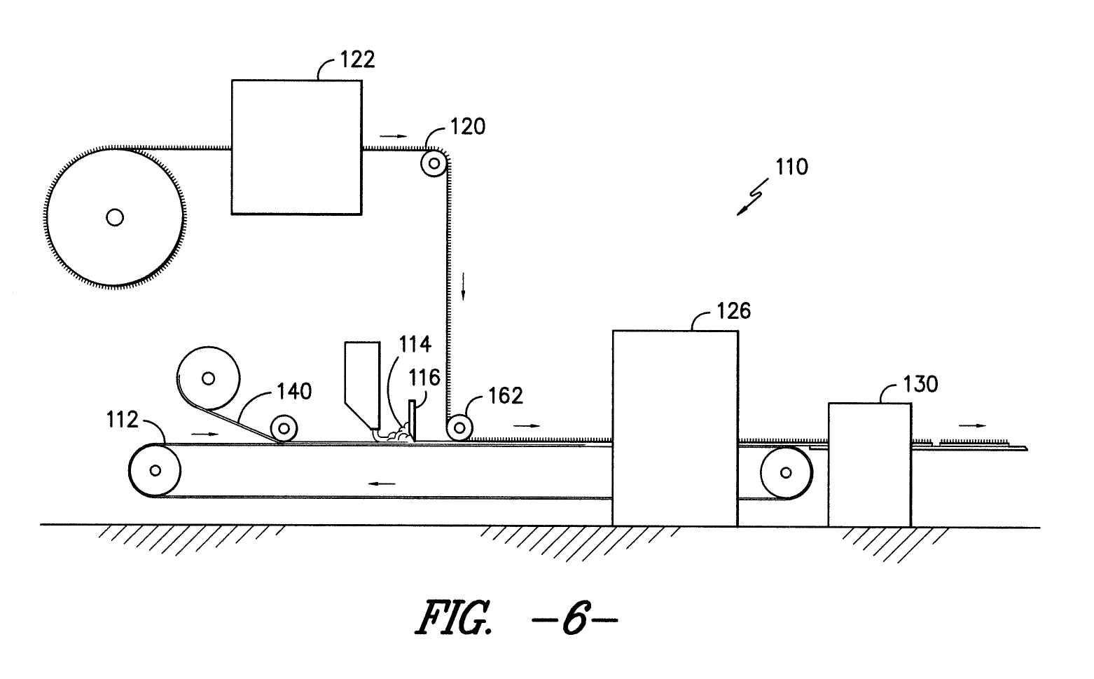

As indicated previously, it is also contemplated that one or more backing or release layers may be applied across the underside of the cured polyurethane facing away from the textile face structure. By way of example only, FIG. 6 illustrates a formation system 110 for production of surface coverings incorporating backed polyurethane, such as felt or scrim backed polyurethane, wherein elements corresponding to those previously described are designated by like reference numerals increased by 100. As will be appreciated, the formation system 110 is substantially identical to the system illustrated and described in relation to FIG. 1 but with the addition of backing material, such as felt 140 across the belt 112 at a position upstream of the location at which the polyurethane composition 114 is deposited.

By way of example only, one felt that may be particularly preferred is a needle punched felt formed from polyester and/or polypropylene as described in U.S. Pat. No. 5,540,968 hereby incorporated by reference herein. Of course other woven and/or non-woven backings may likewise be utilized as desired.

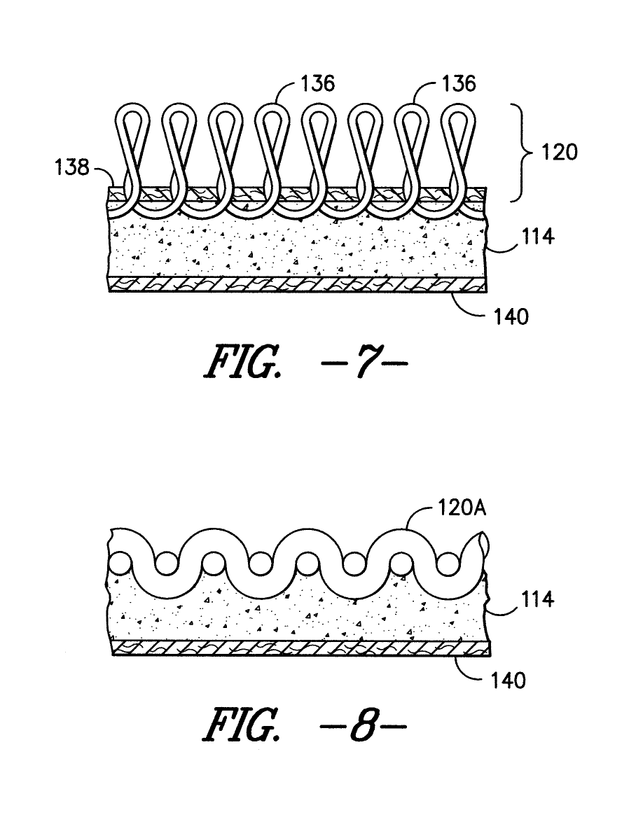

The textile face structure 120 may have any number of suitable constructions. By way of example only, FIGS. 7-10 illustrate a number of backed polyurethane constructions such as may be formed on the system 110 using various face structures.

FIG. 7 illustrates a tufted textile face structure 120 incorporating an arrangement of yarn elements 136 tufted through a primary backing 138 such as a woven, a non-woven or the like. As shown, the cured polyurethane composition 114 extends substantially between the backing, such as non-woven felt or a woven or nonwoven scrim or mesh 140 and the primary backing 138 thereby aiding in locking the yarn elements 136 in place.

FIG. 8 illustrates a woven textile face structure 120A disposed in contacting relation to the cured polyurethane composition 114. As shown, the cured polyurethane composition 114 extends substantially between the backing, such as non-woven felt 140 and the surface of the woven textile face structure 120A and preferably migrates at least partially into the interstices between yarn elements forming the woven textile face structure 120A so as to promote good adhesion.

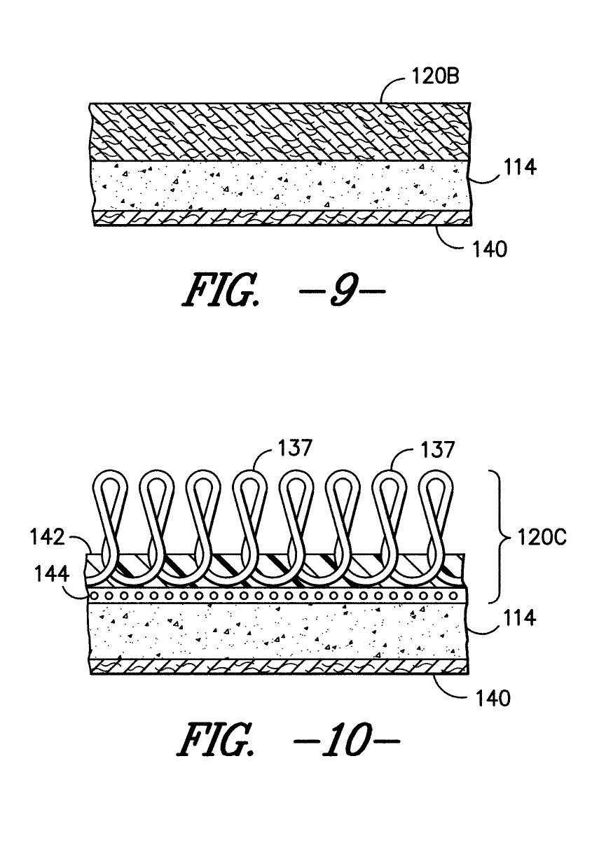

FIG. 9 illustrates a non-woven textile face structure 120B such as a needlepunched, flocked, spun bond or other non-woven construction disposed in contacting relation to the cured polyurethane composition 114. As shown, the cured polyurethane composition 114 extends substantially between the felt backing, such as a non-woven 140 and the surface of the non-woven textile face structure 120B and preferably migrates at least partially into the interstices between fiber elements forming the non-woven textile face structure 120B so as to promote good adhesion.

FIG. 10 illustrates a bonded yarn textile face structure 120C incorporating an arrangement of yarn elements 137 bonded in place across a primary backing or substrate layer 144 by an adhesive 142 disposed across the upper surface of the primary backing layer 144. As shown, the cured polyurethane composition 114 preferably extends substantially between the backing, such as a non-woven felt 140 and the primary backing 144.

The backings 140 of FIGS. 6-10 may be a woven, non-woven, or combined woven and non-woven material or fabric, a film, a scrim, a mesh, or combinations thereof. In accordance with one example, the backing 140 is a non-woven bonded glass scrim material marketed as STABILON TRIAX™ by Milliken & Company of Spartanburg, S.C. It is preferred that the backing 140 be a flexible material which prevents growth and which tends to prevent curling of the surface covering 120 (such as a carpet tile). A glass scrim, mat, or the like may be preferred.

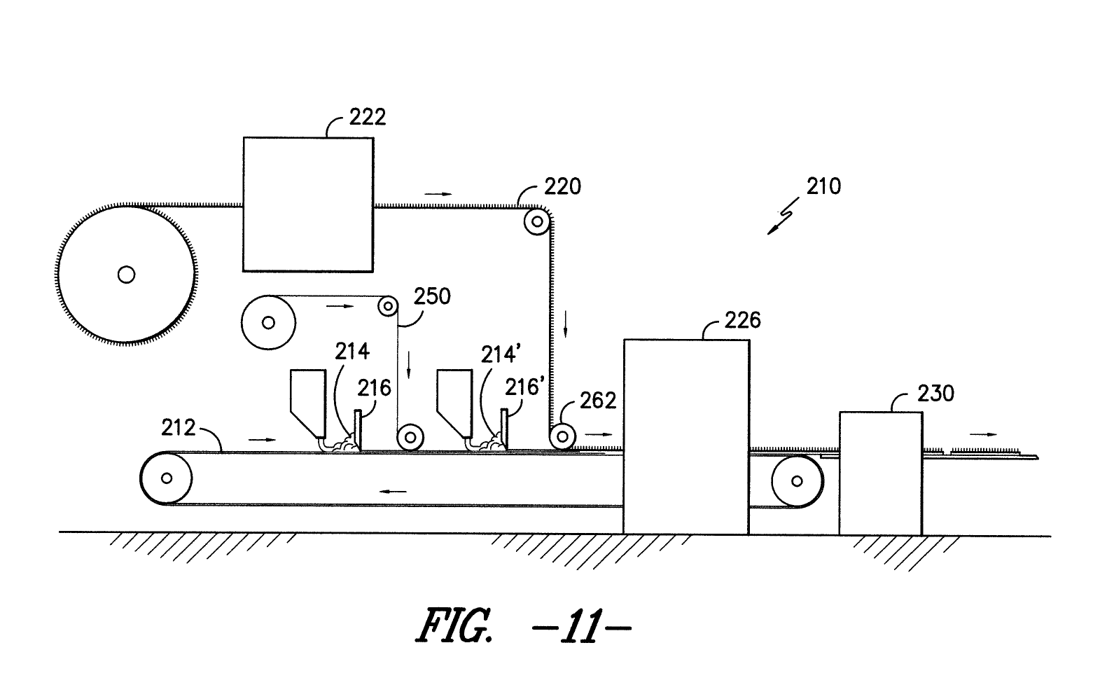

As indicated previously, it is also contemplated that one or more structural support layers may be placed within, over, or under the cured polyurethane. By way of example only, FIG. 11 illustrates a formation system 210 for production of surface coverings incorporating polyurethane with an intermediate structural support layer, wherein elements corresponding to those previously described are designated by like reference numerals in a 200 series.

As will be appreciated, the formation system 210 is substantially identical to the system illustrated and described in relation to FIG. 1 but with the addition of a structural support layer 250, such as a glass mat or scrim, between deposited layers of polyurethane composition 214, 214′. As shown, in the illustrated practice the structural support layer 250 is placed in contacting overlying relation to a first layer of polyurethane composition 214 following a first leveler 216. A second layer of polyurethane composition 214′ is then applied across the structural support layer 250 followed by a leveler 216′ thereby yielding a sandwich structure for application of the textile face structure 220.

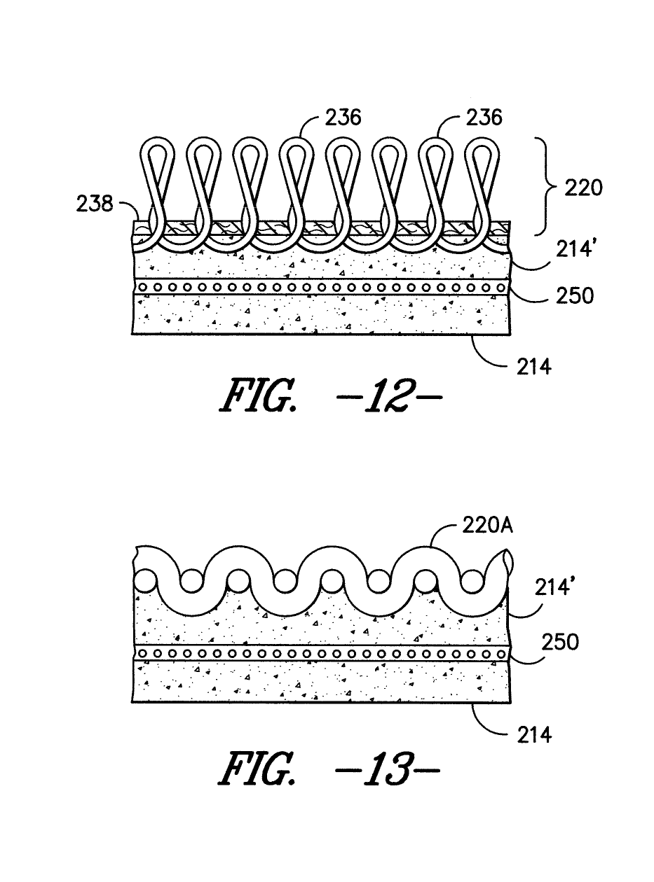

With reference to FIGS. 11-15, 23 and 24 of the drawings, the location of support, stabilizing or reinforcement layer or material 250 can be determined by the amount of polyurethane composition added upstream and downstream of the support layer 250. Although it may be preferred that the support layer 250 be located at the top of, in the middle of, or at the bottom of the polyurethane backing (FIGS. 23, 12, and 24, respectively), it may be located anywhere in between by controlling the add of polyurethane 214 and 214′ in the system of FIG. 11.

By way of example only, one structural support layer 250 is in the form of woven or non-woven glass, although other materials including polyester, polypropylene, and the like may also be utilized if desired. The textile face structure 220 may have any number of suitable constructions. By way of example only, FIGS. 12-15 illustrate a number of constructions incorporating a structural support layer 250 such as may be formed on the system 210 using various face structures.

FIG. 12 illustrates a tufted textile face structure 220 incorporating an arrangement of yarn elements 236 tufted through a primary backing 238 such as a scrim, a non-woven or the like. As shown, the upper layer of cured polyurethane composition 214′ extends substantially between the structural support layer 250 and the primary backing 238 thereby aiding in locking the yarn elements 236 in place. The lower layer of cured polyurethane composition 214 extends away from the structural support layer 250 to define a lower surface.

FIG. 13 illustrates a woven textile face structure 220A disposed in contacting relation to the upper layer of cured polyurethane composition 214′. As shown, the upper layer of cured polyurethane composition 214′ extends substantially between the structural support layer 250 and the underside of the woven textile face structure 220A and preferably migrates at least partially into the interstices between yarn elements forming the woven textile face structure 220A so as to promote good adhesion. The lower layer of cured polyurethane composition 214 extends away from the structural support layer 250 to define a lower surface.

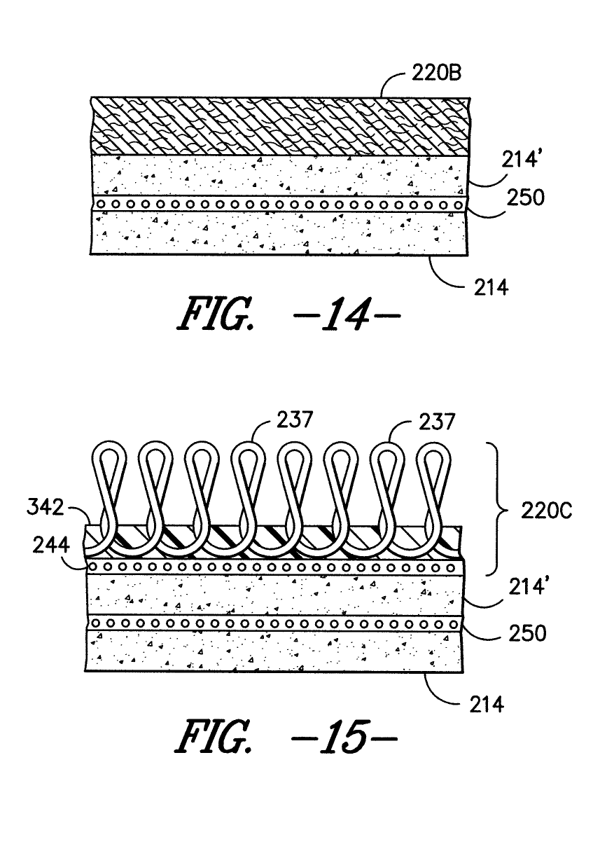

FIG. 14 illustrates a non-woven textile face structure 220B such as a needlepunched, flocked, spun bond or other non-woven construction disposed in contacting relation to the upper layer of cured polyurethane composition 214′. As shown, the upper layer of cured polyurethane composition 214′ extends substantially between the structural support layer 250 and the underside of the non-woven textile face structure 220B and preferably migrates at least partially into the interstices between fiber elements forming the non-woven textile face structure 220B so as to promote good adhesion. The lower layer of cured polyurethane composition 214 extends away from the structural support layer 250 to define a lower surface.

FIG. 15 illustrates a bonded yarn textile face structure 220C incorporating an arrangement of yarn elements 237 bonded in place across a primary backing or substrate layer 244 by an adhesive 242 disposed across the upper surface of the primary backing layer 244. As shown, the upper layer of cured polyurethane composition 214′ extends substantially between the structural support layer 250 and the underside of the primary backing layer 244. The lower layer of cured polyurethane composition 214 extends away from the structural support layer 250 to define a lower surface.

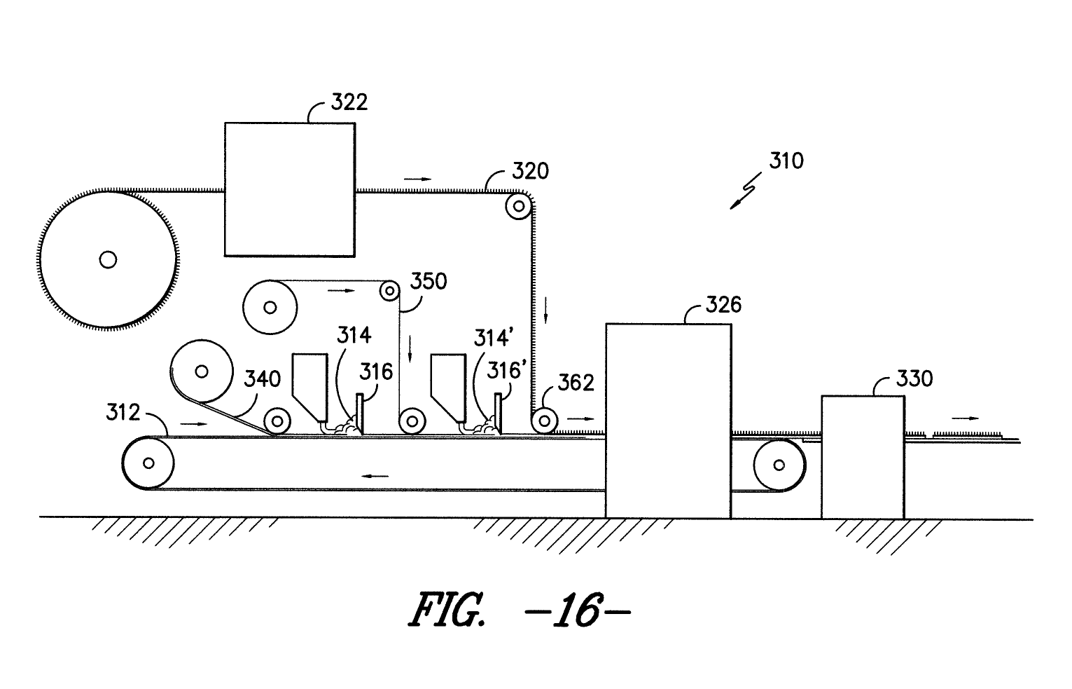

It is also contemplated that combinations of structural support layers and backings, such as felt backings, may be utilized. By way of example only, FIG. 16 illustrates a formation system 310 for production of surface coverings incorporating polyurethane with an intermediate structural support layer and with a backing. In this figure and related figures, elements corresponding to those previously described are designated by like reference numerals within a 300 series. As will be appreciated, the formation system 310 is substantially identical to the system illustrated and described in relation to FIG. 11 but with the addition of a layer of backing such as felt 340 across the belt 312 at a position upstream of the location at which the polyurethane composition 314 is deposited.

As shown, in the illustrated practice a first layer of polyurethane composition 314 is deposited over the backing material or layer 340 and leveled by a first leveler 316. The structural support layer 350 is placed in contacting overlying relation to the first layer of polyurethane composition 314 following a first leveler 316. A second layer of polyurethane composition 314′ is then applied across the structural support layer 350 followed by a leveler 316′ thereby yielding a stabilized and backed sandwich structure for application of the textile face structure 320.

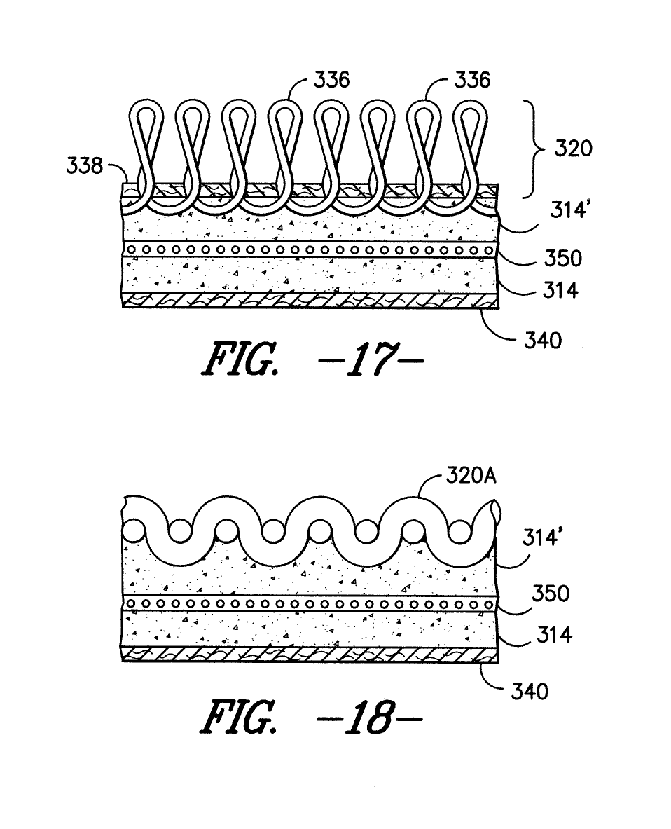

The textile face structure 320 may have any number of suitable constructions. By way of example only, FIGS. 17-20 illustrate a number of constructions incorporating a structural support layer 350 and a backing 340 such as may be formed on the system 310 using various face structures.

FIG. 17 illustrates a tufted textile face structure 320 incorporating an arrangement of yarn elements 336 tufted through a primary backing 338 such as a woven, a non-woven or the like. As shown, the upper layer of cured polyurethane composition 314′ extends substantially between the structural support layer 350 and the primary backing 338 thereby aiding in locking the yarn elements 336 in place. The lower layer of cured polyurethane composition 314 extends away from the structural support layer 350 to the backing layer 340.

FIG. 18 illustrates a woven textile face structure 320A disposed in contacting relation to the upper layer of cured polyurethane composition 314′. As shown, the upper layer of cured polyurethane composition 314′ extends substantially between the structural support layer 350 and the underside of the woven textile face structure 320A and preferably migrates at least partially into the interstices between yarn elements forming the woven textile face structure 320A so as to promote good adhesion. The lower layer of cured polyurethane composition 314 extends away from the structural support layer 350 to the backing layer 340.

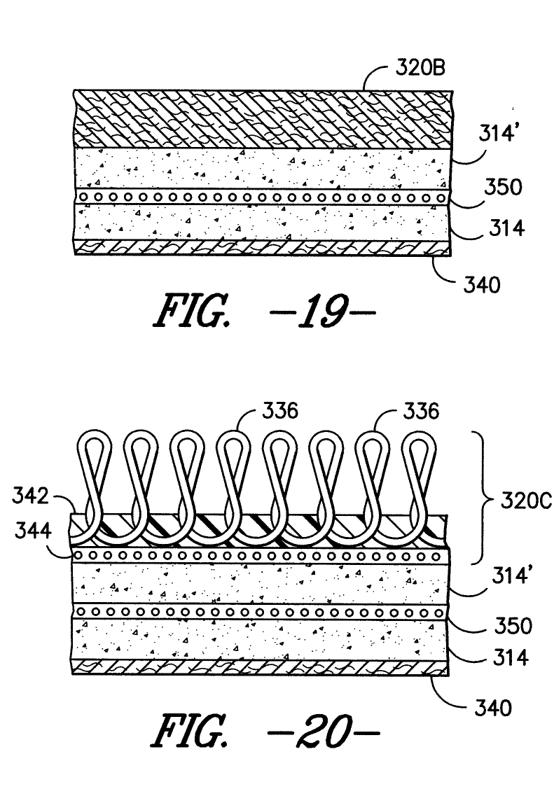

FIG. 19 illustrates a non-woven textile face structure 320B such as a needlepunched, flocked, spun bond or other non-woven construction disposed in contacting relation to the upper layer of cured polyurethane composition 314′. As shown, the upper layer of cured polyurethane composition 314′ extends substantially between the structural support layer 350 and the underside of the non-woven textile face structure 320B and preferably migrates at least partially into the interstices between fiber elements forming the non-woven textile face structure 320B so as to promote good adhesion. The lower layer of cured polyurethane composition 314 extends away from the structural support layer 350 to the backing layer 340.

FIG. 20 illustrates a bonded yarn textile face structure 320C incorporating an arrangement of yarn elements 337 bonded in place across a primary backing or substrate layer 344 by an adhesive 342 disposed across the upper surface of the primary backing layer 344. As shown, the upper layer of cured polyurethane composition 314′ extends substantially between the structural support layer 350 and the underside of the primary backing layer 340. The lower layer of cured polyurethane composition 314 extends away from the structural support layer 350 to the layer of felt 340.

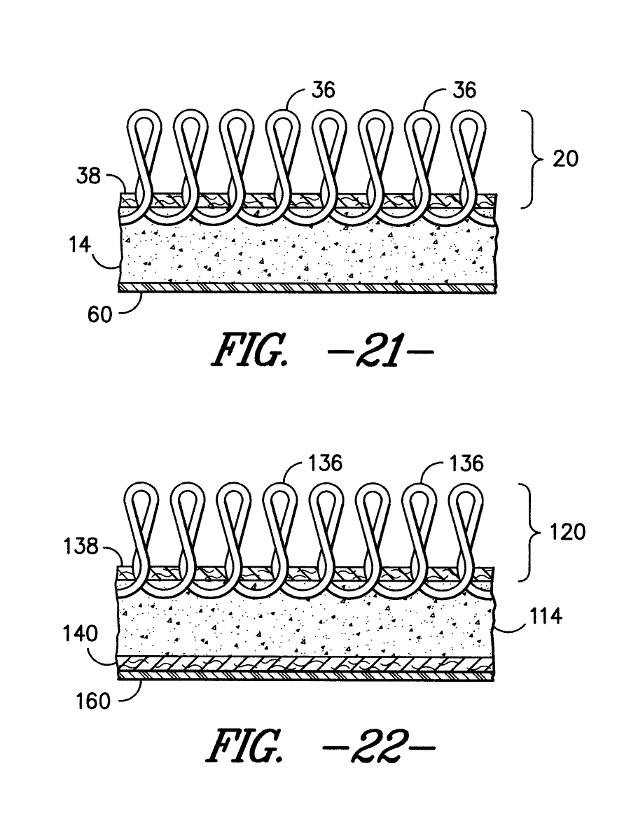

With reference to FIG. 21, a tufted face surface covering like that of FIG. 2 is shown with a backing 60 such as a coating, film, or the like. For example, backing 60 may be an adhesive or other friction enhancing coating such as TractionBack coating offered by Milliken & Company of LaGrange, Ga.

The underside or lower surface of polyurethane layer 14 or 214 may be textured, embossed, cleated, nubbed, ribbed, or the like to, for example, increase sliding friction with a floor or subfloor. Likewise, the lower surface of backing 140, 340, or 250, or of coating or film 60 or 160 may be embossed, textured, or the like.

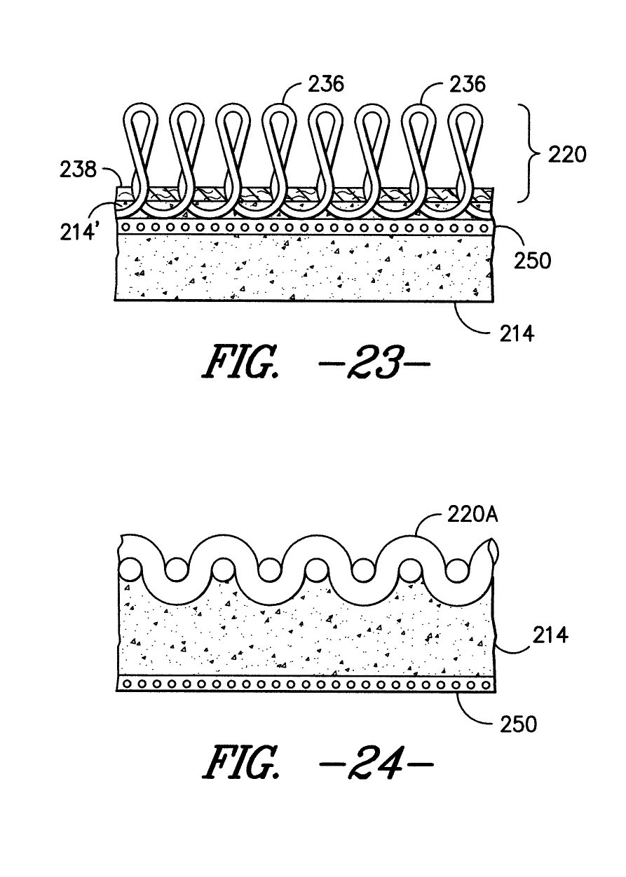

The tufted face surface covering of FIG. 22 is like that of FIG. 7 with the addition of backing 160 such as a coating, film, or the like.

The tufted face surface covering of FIG. 23 is like that of FIG. 12 except that the support layer 250 is shown just below tufts 236.

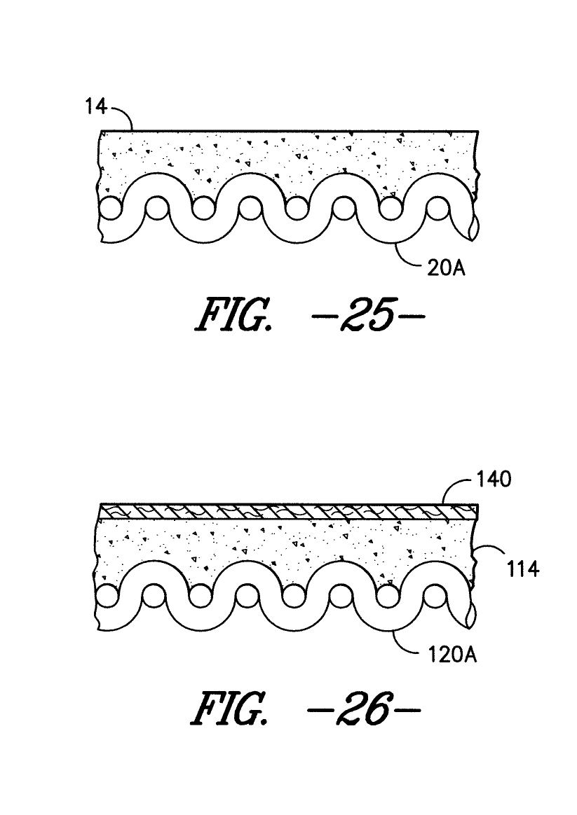

The woven face surface covering of FIG. 24 is like that of FIG. 13 except that the support layer 250 is shown at the bottom of polyurethane 214.

FIGS. 25-27 relate to an alternative production process wherein the face material 20, 120, 220 is inverted and then laid on the belt 112. Next, polyurethane composition 114 is poured or applied to the back of the face material 20A or 120A and doctored by blade 116.

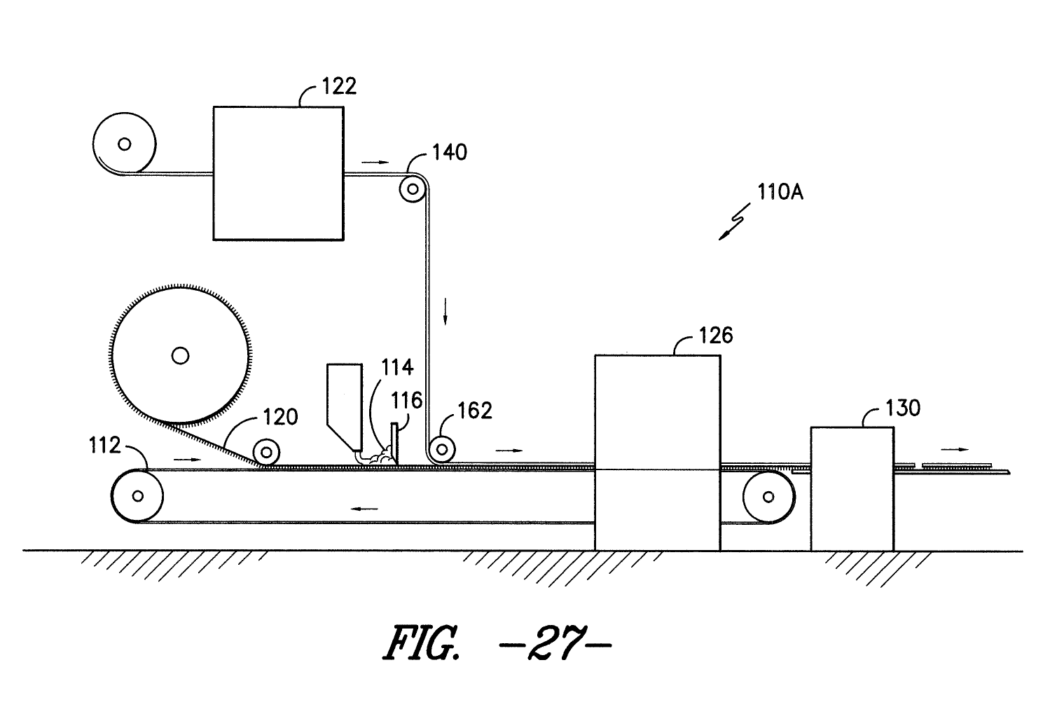

With respect to FIGS. 26 and 27, a backing 140 is added over the polyurethane 114 and nip or gauge roll 162 presses backing 140 into the polyurethane 114.

One advantage of the system 110A of FIG. 27 is that the face material 120 tends to keep the belt 112 clean of polyurethane 114.

The face material 20, 20A, 20B, 20C, 120, 120A, ′120B, 120C, 220, 220A, 220B, 220C, 320, 320A, 320B, and 320C may be formed of natural or synthetic fibers or materials, or blends thereof. For example, tufts 36 may be Nylon 6, Nylon 6,6, polyolefin, wool, or blends thereof.

If face material 20 must be dyed or printed, it is preferred that it be dyed prior to addition of polyurethane 14.

Polyurethane 14 may include a polyol component, an isocyanate component, a catalyst, and other agents, fillers, additives, and the like. It has been discovered that the catalyst may be eliminated, that the polyol may be replaced with castor oil, or both.

In accordance with at least selected examples, castor oil was used in place of the polyol component of a two component MDI based polyurethane system typically having a polyol component and an isocyanate component (in grams or parts).

A. 16 g 100×325 mesh mixed fines (MF) glass
49 g coal fly ash (CFA)
12 g castor oil
23 g isocyanate
drop dibutyl tin dilaurate (about 0.026 g) catalyst

B. 16 g 100×325 mesh mixed fines (MF) glass
49 g coal fly ash (CFA)
12 g castor oil
8 g inert oil
23 g isocyanate
drop dibutyl tin dilaurate (about 0.026 g) catalyst

C. 16 g 100×325 mesh mixed fines (MF) glass
49 g coal fly ash (CFA)
20 g castor oil
23 g isocyanate
drop dibutyl tin dilaurate (about 0.026 g) catalyst

D. 65 g coal fly ash (CFA)
20 g castor oil
23 g isocyanate
2 drops catalyst

E. 16 g 100×325 mesh mixed fines (MF) glass
49 g coal fly ash (CFA)
18 g castor oil
23 g isocyanate
2 drops catalyst

F. 32.5 g bone meal
13 g castor oil
13 g isocyanate
3 drops catalyst

G. 65 g bone meal
26 g castor oil
26 g isocyanate
0.23 mL catalyst

H. 65 g 40 mesh gypsum from recycled drywall
49 g castor oil
46 g isocyanate
0.46 mL dibutyl tin dilaurate
0.46 mL water

I. 30 g gypsum wet with 15 g water
10 g castor oil
10 g isocyanate
0.1 mL dibutyl tin dilaurate

J. 16 g 100×325 mesh mixed fines (MF) glass
49 g coal fly ash (CFA)
17 g castor oil
23 g isocyanate
0.5 mL dibutyl tin dilaurate

K. 16 g 100×325 mesh mixed fines (MF) glass
49 g coal fly ash (CFA)
16 g castor oil
23 g isocyanate
0.5 mL dibutyl tin dilaurate

L. 65 parts 100×325 mesh mixed fines (MF)
crushed post-consumer glass
23 g isocyanate
12 parts castor oil
0.026 parts dibutyl tin dilaurate catalyst

M. 62.5 parts coal fly ash (PV 20A)
10 parts castor oil
9.93 parts PPG polyol MW 6000 f=3
17.57 parts prepolymer isocyanate
dibutyl tin dilaurate catalyst

N. 62.5 parts coal fly ash (PV 20A)
13.52 parts castor oil
13.43 parts PPG polyol MW 6000 f=3
5.26 parts isocyanate
5.29 parts prepolymer isocyanate
dibutyl tin dilaurate catalyst

O. 62.5 parts coal fly ash (PV 20A)
15.04 parts castor oil
14.94 parts PPG polyol MW 6000 f=3
7.52 parts isocyanate
dibutyl tin dilaurate catalyst

P. 62.5 parts coal fly ash (PV 20A)
13.62 parts castor oil
13.55 parts PPG polyol MW 6000 f=3
4.98 parts isocyanate
5.34 parts prepolymer isocyanate
dibutyl tin dilaurate catalyst

Polyurethane 14 may include a polyol component, an isocyanate component, a catalyst, and other agents, fillers, additives, and the like. It has been discovered that the petrochemical polyol may be replaced with chemically unmodified (preferably filtered and dried) castor oil (a natural oil polyol).

In accordance with at least selected examples, castor oil is used in place of at least the major polyol component of a two component MDI based polyurethane system typically having a petrochemical or petroleum based polyol or polyol blend component and an isocyanate component (in grams or parts).

Q. 16 g 100×325 mesh mixed fines (MF) glass
49 g coal fly ash (CFA)
12 g dry, filtered castor oil
23 g isocyanate
drop dibutyl tin dilaurate (about 0.026 g) catalyst

R. 16 g 100×325 mesh mixed fines (MF) glass
49 g coal fly ash (CFA)
12 g dry, filtered castor oil
8 g inert oil
23 g isocyanate

S. 69 g coal fly ash (CFA)
20 g castor oil
23 g isocyanate

T. 65 g coal fly ash (CFA)
20 g dry, filtered castor oil
23 g isocyanate
2 drops catalyst

U. 16 g 100×325 mesh mixed fines (MF) glass
49 g coal fly ash (CFA)
18 g castor oil
6 g PPG polyol
29 g isocyanate
2 drops catalyst

V. 32.5 g bone meal
13 g castor oil
5 g PEG polyol
18 g isocyanate
3 drops catalyst

W. 65 g bone meal
26 g castor oil
13 g PPG-PEG copolymer polyol
39 g isocyanate
0.23 mL catalyst

X. 65 g 40 mesh gypsum from recycled drywall
49 g castor oil
12 g minor polyol with functionality of 2 or 3 and a molecular weight ranging from 750 to 7500
58 g isocyanate
0.46 mL dibutyl tin dilaurate

Y. 30 g gypsum wet with 15 g water
10 g dry castor oil
10 g isocyanate

Z. 16 g 100×325 mesh mixed fines (MF) glass
49 g coal fly ash (CFA)
17 g polyurethane grade, dry castor oil
23 g isocyanate
0.5 mL dibutyl tin dilaurate

AA. 16 g 100×325 mesh mixed fines (MF) glass
49 g coal fly ash (CFA)
16 g polyurethane grade castor oil
23 g isocyanate
0.5 mL dibutyl tin dilaurate

BB. 65 parts 100×325 mesh mixed fines (MF)
crushed post-consumer glass
23 parts isocyanate
12 parts castor oil

CC. at least 42% by weight coal fly ash (CFA)
unmodified, dry, filtered castor oil
isocyanate

DD. at least 50% by weight coal fly ash (CFA)
castor oil
optional additional polyol
isocyanate
optional catalyst

EE. at least 60% by weight coal fly ash (CFA)
castor oil
isocyanate
optional catalyst

FF. at least 70% by weight coal fly ash (CFA)
castor oil
optional additional polyol
isocyanate
optional catalyst

GG. coal fly ash (CFA)
castor oil
polyol blend
isocyanate
optional catalyst

HH. coal fly ash (CFA)
castor oil
isocyanate blend
optional catalyst

II. coal fly ash (CFA)
castor oil
prepolymer isocyanate
optional catalyst

JJ. coal fly ash (CFA)
castor oil
prepolymer isocyanate blend
optional catalyst

KK. coal fly ash (CFA)
castor oil
optional polyol blend
prepolymer isocyanate
optional catalyst

LL. 62.5 parts coal fly ash (PV 20A)
10 parts castor oil
4.97 parts PPG polyol MW 3,000 f=3
17.57 parts prepolymer isocyanate
optional catalyst

MM. 62.5 parts coal fly ash (PV 20A)
13.52 parts castor oil
6.72 parts PPG polyol MW 3000 f=3
5.26 parts isocyanate
5.29 parts prepolymer isocyanate
dibutyl tin dilaurate catalyst

NN. 62.5 parts coal fly ash (PV 20A)
15.04 parts castor oil
7.47 parts PPG polyol MW 3000 f=3
7.52 parts isocyanate
dibutyl tin dilaurate catalyst

OO. 62.5 parts coal fly ash (PV 20A)
13.62 parts castor oil
6.78 parts PPG polyol MW 3000 f=3
4.98 parts isocyanate
5.34 parts prepolymer isocyanate
dibutyl tin dilaurate catalyst

PP. 62.5 parts coal fly ash (PV 20A)
13.52 parts castor oil
13.43 parts PPG polyol MW 4000 f=2
5.26 parts isocyanate
5.29 parts prepolymer isocyanate
dibutyl tin dilaurate catalyst

QQ. 62.5 parts coal fly ash (PV 20A)
15.04 parts castor oil
14.94 parts PPG polyol MW 4000 f=2
7.52 parts isocyanate
dibutyl tin dilaurate catalyst

RR. 62.5 parts coal fly ash (PV 20A)
13.62 parts castor oil
6.78 parts PPG polyol MW 2000 f=2
4.98 parts isocyanate
5.34 parts prepolymer isocyanate
dibutyl tin dilaurate catalyst

SS. 62.5 parts coal fly ash (PV 20A)
13.52 parts castor oil
6.72 parts PPG polyol MW 2000 f=2
5.26 parts isocyanate
5.29 parts prepolymer isocyanate
dibutyl tin dilaurate catalyst

In accordance with another possibly preferred embodiment of the present invention, the preferred filler is a post-consumer recycled soda lime glass having a pH in deionized water of greater than 8.4, more preferably greater than 9.0, most preferably greater than 10.0.

In accordance with one test in deionized water, the recycled soda lime glass had a pH of 10.73, in another test the pH was 9.24.

Such a recycled soda lime glass also has the following specifications:

### I. Product Information

| | |
|---|---|
| Product Name: | Cullet - Recycled Glass |
| Chemical Family: | Silicon |
| Synonyms: | Soda Lime Glass, Crushed Glass |
| Formula: | SiO₂ + Metal Oxides (Na₂O, CaO, A1₂O₃) |
| CAS Number: | None |
| DOT Shipping Name: | None |
| DOT Shipping ID No.: | N/A |
| DOT Hazard Class: | N/A |
| EPA Hazard Waste Class: | None |
| EPA Hazard Waste ID No.: | None |
| Moisture: | 0.1% max |
| LOI: | 0.1% max |
| Tramp Metals: | 0.01% max |

### II. Chemical Composition

| NAME | % | ACGIH TLV | OSHA PEL | CAS # |
|---|---|---|---|---|
| Soda Lime Glass | 100 | 10 mg/M³ | *15 mg/M³ | None |
| | | | *5 mg/M³ | |

(OSHA PEL based on Nuisance Dust)
*Total Dust
** Respirable Dust

### III. Physical Properties

| | | | |
|---|---|---|---|
| Boiling Point: | N/A | Vapor Density (Air-1): | N/A |
| Melting Point: | 3100° F. or | Specific Gravity | 2 |
| | 1704° C. | (Water = 1): | |
| Vapor Pressure | N/A | % Volatile: | None |
| (mmHg): | | | |
| Solubility in Water: | Insoluble | | |
| Evaporation Rate: | N/A | | |
| Appearance & Odor: | Solid having | | |
| | variable | | |
| | appearance | | |
| | without odor. | | |

### IV. Reactivity Data

| | |
|---|---|
| Stability: | Stable |
| Incompatibilities: | None |
| Hazardous Decomposition Products: | None |
| Conditions to Avoid: | None |
| Hazardous Polymerization: | Will not occur |
| Conditions to Avoid: | None |

### V. Sizes

70 to 100 mesh, 100 to 120 mesh, 70 to 325 mesh, 80 to 325 mesh, 100 to 325 mesh

### VI. Source

100% post-consumer glass from private and municipal recycling programs.

In accordance with another example, one can blend recycled post-industrial waste filler (such as coal fly ash) with recycled post-consumer waste filler (such as crushed glass) to produce a hybrid recycled filler.

In accordance with still another example, one can mix recycled post-industrial filler and recycled post-consumer filler, with renewable or bio-based fillers or extenders such as cork, wood, corn, and/or the like.

The surface coverings of the present invention may be hardback or cushion back products. For example, the precoat, the tiecoat, and the backing may each be foam or non-foam layers. In accordance with one example, the precoat is non-foamed and the backing is foamed. It may be preferred that the polyurethane composition layer form a precoat, tiecoat, or backing, a combined precoat and tiecoat, a combined precoat and backing, a combined tiecoat and backing, or the like. One can increase the cushion or resilience of the backing by adding more air, more blowing agent, felt, thickness, or the like. It is possibly preferred that a polyurethane hardback or cushion back product such as a polyurethane hardback or cushion back carpet tile have the structure of one of FIGS. 2-5, 7-10, 12-15, 17-20, and 21-26. It may also be preferred that a polyurethane backed area rug, roll goods, or floor mat of the present invention have the structure of one of FIGS. 2-5, 21, and 25.

In accordance with a particular example of an indoor/outdoor polyurethane backed area rug having a structure like that of FIG. 2, a tufted face greige carpet material (no precoat) had a cut pile, Nylon 6,6, jet dyed, 20 oz/yd² face yarn, 8^{th} gauge, tufted through a 4 oz/yd² non-woven, polyester primary backing, was laid over a mechanically frothed, MDI based polyurethane at a 750 gram cup weight and an average add-on of 27 oz/yd². The uncured polyurethane composition was poured onto a belt, doctored and then joined to the carpet greige goods under a marriage roll. The polyurethane was cured under heat.

In accordance with another example, an indoor/outdoor polyurethane backed area rug had an overall average height of about 7458.03 μm (micrometers), an average polyurethane backing height of about 1507.64 μm (micrometers), and a total weight of about 51.79 oz/yd².

In accordance with at least selected embodiments of the present invention, a nip, marriage, or gauge roll 62 (FIG. 1), 162, (FIG. 6), 262 (FIG. 11), 362 (FIG. 16) presses the face material 20, 120, 220, 320 into the uncured polyurethane composition and sets the height of the total product (prior to any chemical blowing).

The surface covering of the present invention may in at least one embodiment be 6 foot wide roll goods sometimes referred to a 6 foot broadloom.

In accordance with at least selected embodiments, gravitational forces should dominate the sum of other process induced forces. Examples of these other forces are tensions or thermal contractions from cooling.

The gravity model on a cantilever beam:

$${δ}_{B} = \frac{{qL}^{4}}{8 EI} \qquad Eqn . 1$$

This can be simplified for carpet tile applications by:

$${δ}_{B} = \frac{{WL}^{4}}{864 {Et}^{3}} \qquad Eqn . 2$$

### Where:

W=the carpet weight (lbs/yd²)
L=Length of overhang (use 6″ as a constant)
E=Young's Modulus (σ/ε) for the composite
t=the bound thickness (in.)—do not include the pile height
δ=the maximum deflection of the beam (in.)
One can measure the weight (W), deflection (in.), and thickness (in.) in order to calculate the modulus (psi or pounds per square inch).
Assume W is held constant at 8 lbs/yd² (or 128 oz/yd²). Further assume t is held constant at 0.20 in. One can then see the relationship between δ and E.
If we now hold the Modulus constant (e.g., E=1,000 psi), one can illustrate the relationship between δ and t.
Finally, one can hold thickness and modulus constant and illustrate the relationship of δ and W.
Note that in each of these examples the equations assume that the angle of deflection is small such that the trigonometric approximation of sin (Y)=Y. In this case, we want large deflections, so these become qualitative rather than quantitative figures.

In accordance with at least one aspect of the present invention, we want to increase weight, reduce thickness, and reduce modulus of the composite. The combination of a thin and heavy backing requires that the backing materials are characterized by higher density. This may be achieved by the selection of dense raw materials such as dense fillers. For example, CaCO₃ is a common filler used in floor covering products. It has a specific gravity (SG) of 2.6. If a filler is selected with a SG greater than 5 and the concentration by weight remained the same (>50%), then a significant shift in the compound density would occur. If the choice was Iron (Fe) with a SG of 7.8 and with a concentration of 70%, then the density could be nearly tripled resulting in a ⅔ reduction in thickness at the same backing weight.

In accordance with at least another aspect of the present invention, we want to increase weight, reduce thickness, increase flexibility, increase resilience, and reduce modulus of the composite. The combination of a thin and heavy backing may require that the backing materials are characterized by higher density. This may be achieved by the selection of dense raw materials such as dense fillers. For example, CaCO₃ is a common filler used in floor covering products. It has a specific gravity (SG) of 2.6. If a filler is selected with a SG greater than 5 and the concentration by weight remained the same (>50%), then a significant shift in the compound density would occur. If the choice was Iron (Fe) with a SG of 7.8 and with a concentration of 70%, then the density could be nearly tripled resulting in a ⅔ reduction in thickness at the same backing weight.

If a ferromagnetic material is selected as the filler, it creates the option of selectively creating permanent magnetic properties in the backing. A magnetron located on or after the production range could be switched on/off to produce the optional magnetic property. If the ferromagnetic material is an oxide, such as ferrite, then the material will not only be dense and magnetizable, but will also starve a fire event from oxygen and self extinguish.

In accordance with at least selected embodiments, an exemplary surface covering such as a lay flat flooring product or tile has an upper show surface and a backing. It is preferred that the show surface such as a carpet or textile material be bonded to the backing during manufacture of the surface covering. The backing preferably has a very low bending modulus (very flexible), a high density, is thin, and is resilient. Flexibility (low modulus) and high density (heavy) may be the two most important factors that effect tile flatness.

The face or upper show surface is preferably an aesthetically pleasing carpet or textile material. For example, a graphics tufted, printed, dyed, or the like decorative carpet or textile (tufted, woven, bonded, nonwoven, flocked, needled, knit, or the like) of natural and/or synthetic fibers such as wool, polyamide (Nylon), polyester, polyolefin, blends, and the like.

Preferably, the face exits the manufacturing process with substantially zero tension and resists growth or shrinkage during product use.

It is contemplated that the lay flat product may be any desired shape and may be in the form of roll goods, modular product, 6-foot broadloom, 12-foot broadloom, carpet, carpet tile, flooring, floor tile, floor covering, floor mat, stabilized broadloom, rug, runner, or the like. For example, a 6-foot wide roll of lay flat composite may be cut into tiles, rugs, mats, runners, and/or the like. The face 12 is not limited to a precoated carpet or greige goods (non-precoated) face material although such a face may be preferred. Also, it may be possibly preferred that the face be range dyed (jet dyed) prior to lamination or backing to further reduce any latent stresses or tensions in the face. Further, lamination or backing of the face may be carried out at a low enough temperature and the face material or materials (for example, primary backing and tufts) may be selected to avoid the addition of stresses or instability (such as shrinkage) during processing, backing, lamination, curing, etc.

In accordance with possibly preferred embodiments, the backing includes one or more stabilizing layers, backing layers, foam or cushion layers, a friction enhancing coating, magnetic or magnetizable particles, remains flexible at standard operating temperatures, and/or the like. In accordance with one example, the backing is a thin (less than about 5 mm, preferably less than about 3 mm), very flexible, dense, resilient, polymeric material.

In accordance with one example, the face is a jet dyed, tufted, polyamide (Nylon) 6 or 6,6 carpet face with a stable primary backing of, for example, woven and/or nonwoven polyamide (Nylon), polyester, and/or stabilized polypropylene.

It may be preferred that the carpet face has a tuft lock or precoat of the same material as backing, for example, a polyurethane precoat and a polyurethane backing, a combined single polyurethane coating that serves as both precoat and tiecoat, or precoat and backing, a nonfoam precoat and a foam backing, a nonfoam precoat and tiecoat and a foam backing, and/or the like.

In accordance with another example, a hardback floor tile has a flexible, heavy (dense), thin backing with the following preferred properties:

1. backing density—about 180 to 250 lbs/ft³ (3-4 g/cc)

2. backing thickness—about 0.15 inch

3. tile drape—about 2 to 4 inches of drape on a 6 inch tile overhang

In accordance with at least selected embodiments of other aspects of the present invention, it may be preferred:
1. To use an adhesive to join a greige tufted substrate to a polyurethane (PU) cushion structure that provides above average wet and dry tuft bind, and PU lamination strength greater than the cohesion of the PU cushion.
   1.1. Adhesive Physical Properties
      1.1.1. High flexibility, low modulus (<3,000 psi)
      1.1.2. non-PVC, non-latex
      1.1.3. composite cuts easily with standard carpet knife
      1.1.4. resin may be an aqueous emulsion, hot melt, or multipart reaction applied with a coating blade, film lamination, or in-situ extrusion at speeds greater than 50 fpm (feet per minute).
   1.2. The adhesive should provide a moisture barrier in the composite structure.
   1.3. The adhesive may optionally contain recycled content.
      1.3.1. >50% recycled content
      1.3.2. preferably post consumer recycled content
   1.4. The adhesive may optionally provide enhanced flammability resistance to meet vertical flammability tests.
      1.4.1. IMO certification (cruise ships)
   1.5. The adhesive may become an after life cycle “zipper” to separate the tufted substrate from the PU cushion structure.
      1.5.1. zipper may be thermal
      1.5.2. zipper may be mechanical
      1.5.3. zipper may be chemical
   1.6. The adhesive used above should be commercially competitive.
2. The composite using the adhesive can be recycled into item 1.3 or into the PU cushion.
   2.1. Rather than separating components, carpet composite may be desized and integrated into the filler integral to the adhesive.
3. The PU cushion structure may be substituted with another cushion material that:
   3.1. Provides economic advantage.
   3.2. Enables an economically viable recyclable composite.
   3.3. Possibly needled felt
   3.4. Possibly resized end of life (EOL) carpet with binder
4. The PU cushion structure may be substituted with another material that:
   4.1. Creates an optional hardback using the same (or expanded) capital investments for the adhesive from item 1.
   4.2. Utilizes recycled content.
   4.3. Provides a clear EOL recycling process.
   4.4. Provides an economic advantage over competitive hardback.
   4.5. Standard carpet knives easily cut the composite.
5. The aforementioned options may create improved products.

In accordance with at least certain other embodiments of other aspects of the present invention, it may be preferred:
1. To use an adhesive to join a greige tufted substrate to a polyurethane (PU) cushion structure that provides above average wet and dry tuft bind, and PU lamination strength greater than the cohesion of the PU cushion.

1.1. The adhesive may provide a moisture barrier in the composite structure.

1.2. The adhesive may optionally contain recycled content.

1.3. The adhesive may optionally provide enhanced flammability resistance to meet vertical flammability tests.

1.4. The adhesive may become an after life cycle “zipper” to separate the tufted substrate from the PU cushion structure.

1.5. The adhesive should be commercially competitive.
2. The composite using the adhesive can be recycled into item 1.2.
3. The PU cushion structure may be substituted with another material that:

3.1. Provides economic advantage.

3.2. Enables an economically viable recyclable composite.
4. The PU cushion structure may be substituted with another material that:

4.1. Creates an optional hardback using the same (or expanded) capital investments for the adhesive from item 1.

4.2. U EV824804738UStilizes recycled content.

4.3. Provides a clear recycling process.

4.4. Provides an economic advantage over competitive hardback.
5. The aforementioned options may create improved products.
6. The aforementioned options should meet customer expectations of fitness for use including installation.

In accordance with yet another example, a lay flat flooring product has a backing that is flexible, dense, thin, and resilient,

flexible—product drape greater than about 2 inches of drape on a 6-inch product overhang or a bending modulus less than about 2000 psi;

dense—backing density of greater than about 20 lbs/ft³;

thin—backing height (thickness) of less than about 10 mm;

resilient—product can be rolled or folded at least once and will go back to a lay flat position.

In accordance with still another example, a lay flat hardback flooring product has a backing that is flexible, dense, thin, and resilient,

flexible—product drape greater than about 3 inches of drape on a 6-inch product overhang or a bending modulus less than about 1000 psi;

dense—backing density of greater than about 50 lbs/ft³;

thin—backing height (thickness) of less than about 5 mm;

resilient—product can be rolled or folded several times and will go back to a lay flat position.

In accordance with still another example, a lay flat cushion back flooring product has a backing that is flexible, dense, thin, and resilient,

flexible—product drape greater than about 2 inches of drape on a 6-inch product overhang or a bending modulus less than about 3000 psi;

dense—backing density of greater than about 15 lbs/ft³;

thin—backing height (thickness) of less than about 15 mm;

resilient—product can be rolled or folded at least once and will go back to a lay flat position.

In accordance with a possibly preferred example, a lay flat hardback flooring product has a backing that is flexible, dense, thin, and resilient,

flexible—product drape greater than about 4 inches of drape on a 6-inch product overhang or a bending modulus less than about 500 psi;

dense—backing density of greater than about 200 lbs/ft³;

thin—backing height (thickness) of less than about 3 mm;

resilient—product can be rolled or folded many times and will go back to a lay flat position.

In accordance with yet another example, a lay flat carpet tile product has a backing that is flexible, dense, thin, and resilient,

flexible—product drape greater than about 2 inches of drape on a 6-inch product overhang;

dense—backing density of greater than about 25 lbs/ft³;

thin—backing height (thickness) of less than about 5 mm;

resilient—product can be rolled or folded at least once and will go back to a lay flat position.

In accordance with still another example, a lay flat roll goods product has a backing that is flexible, dense, thin, and resilient,

flexible—product drape greater than about 4 inches of drape on a 6-inch product overhang;

dense—backing density of greater than about 100 lbs/ft³;

thin—backing height (thickness) of less than about 5 mm;

resilient—product can be rolled or folded several times and will go back to a lay flat position.

In accordance with yet another example, a lay flat floor mat product has a backing that is flexible, dense, thin, and resilient,

flexible—product drape greater than about 2 inches of drape on a 6-inch product overhang;

dense—backing density of greater than about 50 lbs/ft³;

thin—backing height (thickness) of less than about 5 mm;

resilient—product can be rolled or folded at least once and will go back to a lay flat position.

In accordance with a possibly preferred embodiment, a lay flat flooring product includes a face material and a backing bonded thereto during product manufacture.

In accordance with another example, a lay flat flooring product is a laminated composite of a face, a backing, and an adhesive layer there between. The adhesive may be the same material as the backing, may be less filled or unfilled, or may be of a different material. Preferably, the adhesive is flexible, resilient, and thin.

In accordance with one object of the present invention, there is provided a lay flat flooring product comprising an upper show surface disposed in overlying relation to a single or multi-layer, flexible, heavy, thin backing, said backing having at least one of a bending modulus of less than about 3,000 psi, a thickness of less than about 15 mm, and a density of greater than about 15 lbs/ft³.

In accordance with yet another object of the present invention, there is provided a method of producing a lay flat flooring product such as a lay flat tile or roll goods product with a carpet or textile face and a flexible, heavy, thin, resilient backing, comprising the steps of: preparing a backing composition; depositing the backing composition in a layer; placing a carpet or textile face material on the deposited backing layer to form a multi-layer structure; setting or curing the backing so that the backing composition forms a flexible, heavy, thin, resilient backing, and wherein the carpet or textile face material is bonded to the backing.

In accordance with at least one embodiment, a surface covering such as a lay flat flooring product comprises an upper show surface disposed in overlying relation to a single or multi-layer, flexible, heavy, thin backing.

The surface covering above further comprising a fibrous backing sheet disposed across an underside portion of the backing.

The surface covering above, wherein the surface covering is a tile or roll goods.

The surface covering above, wherein the show surface is a decorative textile or carpet layer.

The surface covering above, wherein the carpet or textile is formed of polyester, Nylon, polyolefin, and combinations thereof.

The surface covering above, wherein the carpet or textile is knit, woven, tufted, bonded, nonwoven, needled, and the like.

The surface covering above, wherein the backing is resilient.

The surface covering above, wherein the show surface is disposed in overlying relation to a multi-layer backing.

The surface covering above, wherein the backing includes at least one stabilizing layer.

The surface covering above, wherein said stabilizing layer is at least one of woven or nonwoven glass.

The surface covering above, further comprising a fibrous backing sheet disposed across an underside portion of the backing.

In accordance with at least one embodiment, a method of producing a surface covering such as a lay flat flooring product with a carpet or textile surface and a flexible, heavy, thin, resilient backing, comprises the steps of: preparing a backing composition; depositing the backing composition in a layer; placing a carpet or textile surface material on the deposited backing layer to form a multi-layer structure; pressing the multi-layer structure while setting the backing with, for example, heat so that the backing composition forms a flexible, heavy, thin, resilient backing, and wherein the carpet or textile surface material is bonded to the backing.

The method above wherein the carpet or textile surface material is at least one of graphics tufted, printed or dyed.

The method above wherein one or more additional layers are added in, over or under the backing composition layer.

In at least one embodiment, there is provided a surface covering such as a lay flat flooring product having an upper show surface disposed in overlying relation to a single or multi-layer, flexible, heavy, thin, resilient backing. A fibrous backing sheet may be disposed across an underside of the backing. The surface covering may be a tile or roll goods. The show surface may be a decorative textile or carpet layer.

In accordance with at least one example, a lay flat flooring product comprises an upper show surface disposed in overlying relation to a single or multi-layer, flexible, heavy, thin backing, said backing having at least one of a bending modulus of less than about 3,000 psi, a thickness of less than about 15 mm, and a density of greater than about 15 lbs/ft³.

The product above further comprises a flexible fibrous backing sheet disposed at a position below an underside of the backing.

The product above, wherein the flooring product is one of a tile and roll goods.

The product above, wherein the show surface is a decorative textile or carpet layer.

The product above, wherein the show surface is formed of a material selected from polyester, polyamide (Nylon), polyolefin, and combinations thereof.

The product above, wherein the show surface is one of knit, woven, tufted, bonded, nonwoven, needled, graphics tufted, printed, dyed, and combinations thereof.

The product above, wherein the backing is resilient.

The product above, wherein the show surface is disposed in overlying relation to a multi-layer backing.

The product above, wherein the backing includes at least one stabilizing layer.

The product above, wherein said stabilizing layer is at least one of woven or nonwoven glass.

The product above, wherein said backing has a bending modulus of less than about 3,000 psi, a thickness of less than about 15 mm, and a density of greater than about 15 lbs/ft³.

The product above, wherein said backing preferably has a bending modulus of less than about 2,000 psi, a thickness of less than about 10 mm, and a density of greater than about 20 lbs/ft³.

The product above, wherein said backing has a bending modulus of less than about 1,000 psi, a thickness of less than about 5 mm, and a density of greater than about 50 lbs/ft³.

The product above, wherein said backing has a bending modulus of less than about 1,000 psi, a thickness of less than about 4 mm, and a density of greater than about 100 lbs/ft³.

The product above, wherein said backing has a bending modulus of less than about 500 psi, a thickness of less than about 3 mm, and a density of greater than about 200 lbs/ft³.

In accordance with at least one embodiment, a method of producing a lay flat flooring product such as a lay flat tile or roll goods product with a carpet or textile face and a flexible, heavy, thin, resilient backing, comprising the steps of: preparing a backing composition; depositing the backing composition in a layer; placing a carpet or textile face material on the deposited backing layer to form a multi-layer structure; setting or curing the backing so that the backing composition forms a flexible, heavy, thin, resilient backing, and wherein the carpet or textile face material is bonded to the backing.

The method above wherein the carpet or textile face material is at least one of graphics tufted, printed or dyed.

The method above further comprising the step of adding one or more additional layers in, over or under the backing composition.

In accordance with at least one embodiment, a method of producing a lay flat flooring product such as a lay flat tile or roll goods product with a carpet or textile face, and a flexible, heavy, thin, resilient backing, comprising the steps of: preparing a backing composition; inverting a carpet or textile face material; depositing the backing composition on the inverted face material to form a multi-layer structure; setting or curing the backing so that the backing composition forms a flexible, heavy, thin, resilient backing, and wherein the carpet or textile face material is bonded to the backing.

The method above, wherein the carpet or textile face material is at least one of graphics tufted, printed, and dyed.

The method above further comprising the step of adding one or more additional layers in, over or under the backing composition layer.

A lay flat flooring product produced by one of the methods above.

In accordance with at least selected examples, the preferred backing is filled polyurethane (greater than 50% by weight filled). Although less preferred, other materials which will provide a relatively heavy, thin, flexible, and resilient backing may be used. For example, rubber, latex, extruded polymers, hot melts, adhesives, films, acrylics, and the like may be used.

In accordance with at least selected examples, the preferred adhesive is an unfilled or lightly filled polyurethane (less than 20% by weight filled). Although polyurethane adhesive is preferred, other known adhesives may be used. For example, hot melts, polymers, polyolefins, extruded polymers, acrylics, or the like.

In accordance with at least selected examples, the preferred fillers are dense fillers having, for example, a specific gravity (SG) greater than 2. Exemplary fillers include magnetite, iron oxides, ferrite, iron, steel, nickel, metals, recycled metals, barite, sand, foundry sand, used foundry sand, glass, recycled glass, recycled soda lime glass, glass particles, glass fibers, gypsum, recycled gypsum, coal fly ash, calcium carbonate, blends and combinations thereof. Fillers are typically added in amounts by weight totaling from 0% to about 95%.

In accordance with at least one embodiment, fillers with a specific gravity (SG) over 5 are preferred (such as iron oxide).

In accordance with at least one other embodiment, magnetic or magnetizable filler materials are preferred. Such ferromagnetic fillers may be added at 5% by weight or greater filler loads, preferably 10% or greater by weight.

In accordance with at least one example, a method of producing a lay flat product includes the steps of:

1. Producing a substantially tensionless face;

2. Treating the face to remove stresses;

3. Laminating or backing the face;

4. Selectively magnetizing the composite; and

5. Rolling or cutting the composite to form lay flat products.

In accordance with at least one object of the present invention, there is provided a floor covering product comprising a textile face structure disposed in overlying contacting relation to at least one layer of polyurethane backing composition filled with at least one filler selected from calcium carbonate, sand, used foundry sand, recycled gypsum, recycled glass, glass particles, glass fibers, cork, coal fly ash, recycled metal, rubber, recycled rubber, and combinations thereof.

In accordance with at least one object of the present invention, there is provided a method of forming combinations of floor covering products selected from carpet, carpet tiles, area rugs, floor tiles, runners, mats, and floor mats on a single processing line, the method comprising the steps of:

(a) delivering a mass of polyurethane forming composition onto an endless belt;

(b) leveling the polyurethane forming composition to a desired thickness;

(c) placing a preformed textile face structure into overlying contacting relation with the leveled polyurethane forming composition;

(d) curing the polyurethane forming composition in place across the underside of the textile face structure; and

(e) cutting the composite of textile face structure with cured polyurethane to at least two different sizes.

In accordance with at least one object of the present invention, there is provided a system of polyurethane backed floor covering products such as tiles, mats, roll goods, and the like produced on a single polyurethane range.

The system of floor covering products above wherein each such product includes at least 10% by weight recycled content.

The system of floor covering products above wherein each such product includes at least 10% by weight post consumer recycled content.

In accordance with at least one embodiment, a surface covering such as a floor covering comprises a textile face structure disposed in overlying contacting relation to a layer of filled polyurethane.

The surface covering above further comprising a backing disposed across a side of the layer of polyurethane facing away from the textile face structure.

The surface covering above further comprises a structural support layer disposed in embedded relation within the layer of polyurethane.

The surface covering above, further comprises a structural support layer disposed in embedded relation within the layer of polyurethane and a backing disposed across a side of the layer of polyurethane facing away from the textile face structure.

The surface covering above, wherein the surface covering is a carpet tile, an area rug, or a floor mat.

In accordance with at least one embodiment, a method of forming combinations of the group consisting of carpet, carpet tile, area rugs and floor mats on a single processing line, the method comprises the steps of:

(a) delivering a mass of polyurethane forming composition onto an endless belt;

(b) leveling the polyurethane forming composition to a desired thickness;

(c) placing a preformed textile face structure into overlying contacting relation with the leveled polyurethane forming composition;

(d) curing the polyurethane forming composition in place across the underside of the textile face structure; and

(e) cutting the composite of textile face structure with cured polyurethane to at least two different sizes.

In accordance with at least selected embodiments, there is provided a surface covering such as a carpet, carpet tile, area rug, floor mat or the like incorporating a textile face disposed in contacting overlying relation to at least a polyurethane layer. One or more optional intermediate structure layers may be disposed within, on, over, or under the polyurethane and one or more optional backing layers may be disposed across the underside of the polyurethane.

In accordance with at least one embodiment, a floor covering product comprises a textile face structure disposed in overlying contacting relation to at least one layer of polyurethane backing composition filled with at least one filler selected from calcium carbonate, sand, used foundry sand, recycled gypsum, recycled glass, glass particles, glass fibers, cork, coal fly ash, recycled metal, rubber, recycled rubber, and combinations thereof.

The product above further comprises a backing material disposed at a position below an underside of the layer of polyurethane and operatively bonded thereto.

The product above further comprises at least one structural support layer disposed in, on or over said layer of polyurethane.

The product above further comprises a structural support layer disposed in embedded relation within the layer of polyurethane and a backing material disposed across an underside of the layer of polyurethane.

The product above, wherein the floor covering product is a product selected from carpet, carpet tiles, floor tiles, rugs, mats, floor mats, modular product, roll goods, broadloom carpet, 6 foot broadloom, 12 foot broadloom, runners, and area rugs.

The product above, wherein at least one filler in said layer of polyurethane is post consumer recycled soda lime glass, said recycled soda lime glass having a pH in deionized water of greater than 8.4 and an average particle size of greater than 325 mesh.

The product above, wherein the floor covering product is an outdoor product.

The product above, wherein the floor covering product is an indoor/outdoor product.

The product above, wherein an underside of said layer of polyurethane is at least one of embossed, textured, and treated to enhance at least the sliding friction of said floor covering product with a floor or subfloor.

In accordance with at least one embodiment, a method of forming combinations of floor covering products selected from carpet, carpet tiles, area rugs, floor tiles, runners, mats, and floor mats on a single processing line, the method comprises the steps of:

(a) delivering a mass of polyurethane forming composition onto an endless belt;

(b) leveling the polyurethane forming composition to a desired thickness;

(c) placing a preformed textile face structure into overlying contacting relation with the leveled polyurethane forming composition;

(d) curing the polyurethane forming composition in place across the underside of the textile face structure; and

(e) cutting the composite of textile face structure with cured polyurethane to at least two different sizes.

The method above further comprising the step of adding a release layer, material, or film over the belt prior to the delivering step.

At least two different floor covering products produced by the method above.

A system of polyurethane backed floor covering products as described above such as tiles, mats, roll goods, and the like produced on a single polyurethane range.

The system above, wherein each such product includes at least 10% by weight recycled content.

The system above, wherein each such product includes at least 10% by weight post consumer recycled content.

If face material 20 must be dyed or printed, it is preferred that it be dyed prior to addition of polyurethane 14.

Polyurethane 14 may include a polyol component, an isocyanate component, a catalyst, and other agents, fillers, additives, and the like. It has been discovered that the catalyst may be eliminated, that the polyol may be replaced with castor oil, or both.

The surface coverings of the present invention may be hardback or cushion back products. One can increase the cushion or resilience of the backing by adding more air, more blowing agent, felt, thickness, or the like. It is possibly preferred that a polyurethane hardback or cushion back product such as a polyurethane hardback or cushion back carpet tile have the structure of one of FIGS. 2-5, 7-10, 12-15, 17-20, and 21-26. It may also be preferred that a polyurethane backed area rug, roll goods, or floor mat of the present invention have the structure of one of FIGS. 2-5, 21, and 25.

In accordance with a particular example of an indoor/outdoor polyurethane backed area rug having a structure like that of FIG. 2, a tufted face greige carpet material (no precoat) had a cut pile, Nylon 6,6, jet dyed, 20 oz/yd² face yarn, 8^{th} gauge, tufted through a 4 oz/yd² non-woven, polyester primary backing, was laid over a mechanically frothed, MDI based polyurethane at a 750 gram cup weight and an average add-on of 27 oz/yd². The uncured polyurethane composition was poured onto a belt, doctored and then joined to the carpet greige goods under a marriage roll. The polyurethane was cured under heat.

In accordance with another example, an indoor/outdoor polyurethane backed area rug had an overall average height of about 7458.03 μm (micrometers), an average polyurethane backing height of about 1507.64 μm (micrometers), and a total weight of about 51.79 oz/yd².

In accordance with at least selected embodiments of the present invention, a nip, marriage, or gauge roll 62 (FIG. 1), 162, (FIG. 6), 262 (FIG. 11), 362 (FIG. 16) presses the face material 20, 120, 220, 320 into the uncured polyurethane composition and sets the height of the total product (prior to any chemical blowing).

The surface covering of the present invention may in at least one embodiment be 6 foot wide roll goods sometimes referred to a 6 foot broadloom.

It has been discovered that unmodified castor oil which has preferably been filtered and/or dried (otherwise not chemically modified) serves as an excellent natural oil polyol (or major polyol), reduces or eliminates the need for an additional surfactant, wetting agent, or the like, and facilitates the addition of high filler loads.

In accordance with selected embodiments, polyurethane compositions are formed of castor oil together with one or more optional additional polyols, an isocyanate, an optional filler or fillers, an optional catalyst, and other optional agents, fillers, extenders, coating agents, lubricants, or the like.

In accordance with at least selected embodiments, a carpet tile has a textile face structure disposed in overlying contacting relation to at least one layer of flexible, polyurethane backing composition consisting essentially of castor oil as major polyol, isocyanate, filler, and an optional catalyst, and an optional minor polyol, wherein the filler is at least 42% by weight of the composition and is selected from coal fly ash, recycled gypsum, recycled glass, and combinations thereof.

The carpet tile above, wherein the layer of flexible, polyurethane backing composition is at least one of a precoat, tiecoat, and backing.

The carpet tile above, further including at least one structural support layer disposed in, on, under, or over the layer of flexible, polyurethane backing composition.

In accordance with at least certain embodiments, a carpet tile has a textile face structure disposed in overlying contacting relation to
at least one layer of flexible, polyurethane backing composition,
the polyurethane composition being the reaction product of
   (i) a polyol component in which castor oil is the predominant reactive polyol; and
   (ii) an isocyanate component,
and the polyurethane composition further comprising a filler, the filler being at least 42% by weight of the polyurethane composition and preferably being selected from coal fly ash, recycled gypsum, recycled glass, and combinations thereof.

The carpet tile above, wherein substantially the entire polyol component is castor oil, wherein the polyurethane composition is substantially free of surfactant, wherein the polyurethane composition is substantially free of catalyst, wherein said layer of flexible, polyurethane backing composition is at least one of a precoat, tiecoat, backing, combined precoat/tiecoat, combined precoat/backing, combined tiecoat/backing, combined precoat/tiecoat/backing, and combinations thereof, further including at least one structural support layer disposed in, on, under, or over the layer of flexible, polyurethane backing composition, further comprising at least one backing layer disposed across the underside of said layer of flexible, polyurethane backing composition, wherein the filer component is at least 50% by weight of the polyurethane composition, further comprising a minor polyol component which is not castor oil, wherein the minor polyol component is selected from the group consisting of other natural and/or petrochemical polyols and combinations thereof, wherein the minor polyol component is present in an amount of less than about 50% by weight of the polyol component of the polyurethane composition, wherein the minor polyol component is present in an amount of less than about 10% by weight of the polyurethane composition, wherein the minor polyol component is present in an amount of less than about 7% by weight of the polyurethane composition, and/or wherein the minor polyol component is present in an amount of less than about 5% by weight of the polyurethane composition.

In accordance with at least one embodiment, a polyurethane for application to a tufted, woven, non-woven, bonded, needled, flocked, needle punched, or knit textile face structure, includes a polyol component, an isocyanate component, a catalyst and other agents, fillers, additives, and the like wherein the catalyst is eliminated, the polyol is replaced with castor oil, or both.

In at least one embodiment of a cured flexible polyurethane material, the polyurethane material is the reaction product of
(i) a polyol component in which castor oil is the predominant reactive polyol; and
(ii) an isocyanate component,
   and the polyurethane material further comprising a filler, the filler being at least 42% by weight of the polyurethane material.

In accordance with at least one embodiment of a cured flexible polyurethane material, the polyurethane material is the reaction product of
(i) a polyol component; and
(ii) an isocyanate component,
   and the polyurethane material further comprising a filler, the filler being at least 42% by weight of the polyurethane material and the cured flexible material being formed substantially in the absence of catalyst.

In accordance with at least one embodiment of a cured flexible polyurethane material, the polyurethane material is the reaction product of
(i) a polyol component; and
(ii) an isocyanate component,
   and the polyurethane material further comprising a filler, the filler being at least 42% by weight of the polyurethane material and the cured flexible material being formed substantially in the absence of surfactant, wetting agent, or both.

In accordance with at least one embodiment of a cured flexible reactive elastomer or reactive elastomeric material, the elastomer or elastomeric material is the reaction product of
(i) a polyol component; and
(ii) an isocyanate component,
   and the elastomer or elastomeric material further comprising a filler, the filler being at least 42% by weight of the elastomer or elastomeric material and the cured flexible material being formed substantially in the absence of surfactant, wetting agent, or both. The elastomer or elastomeric material may be used as a precoat, tiecoat and/or backing. The preferred reactive elastomer or elastomeric material may be polyurethane.

In accordance with at least selected embodiments, the polyol component is preferably a polyol component in which castor oil is the predominant reactive polyol.

In accordance with at least selected embodiments, a floor covering product has a textile face structure disposed in overlying contacting relation to at least one layer of polyurethane backing composition filled with at least one filler selected from calcium carbonate, sand, used foundry sand, recycled gypsum, recycled glass, glass particles, glass fibers, cork, coal fly ash, recycled metal, rubber, recycled rubber, and combinations thereof.

The floor covering product above, further comprising a backing material disposed at a position below an underside of the layer of polyurethane and operatively bonded thereto, further comprising at least one structural support layer disposed in, on, under, or over said layer of polyurethane, further comprising a structural support layer disposed in embedded relation within the layer of polyurethane and a backing material disposed across an underside of the layer of polyurethane, wherein the floor covering product is a product selected from carpet, carpet tiles, floor tiles, rugs, mats, floor mats, modular product, roll goods, broadloom carpet, 6 foot broadloom, 12 foot broadloom, runners, and area rugs, wherein at least one filler in said layer of polyurethane is post consumer recycled soda lime glass, said recycled soda lime glass having a pH in deionized water of greater than 8.4 and an average particle size of greater than 325 mesh, wherein the floor covering product is an outdoor product, wherein the floor covering product is an indoor/outdoor product, and/or wherein an underside of said layer of polyurethane is at least one of embossed, textured, and treated to enhance at least the sliding friction of said floor covering product with a floor or subfloor.

In accordance with at least one embodiment, a method of forming combinations of floor covering products selected from carpet, carpet tiles, area rugs, floor tiles, runners, mats, and floor mats on a single processing line, includes the steps of:

(a) delivering a mass of polyurethane forming composition onto an endless belt;

(b) leveling the polyurethane forming composition to a desired thickness;

(c) placing a preformed textile face structure into overlying contacting relation with the leveled polyurethane forming composition;

(d) curing the polyurethane forming composition in place across the underside of the textile face structure; and

(e) cutting the composite of textile face structure with cured polyurethane to at least two different sizes.

The method above, further comprising the step of adding a release layer, material, or film over the belt prior to the delivering step, producing at least two different floor covering products, producing a system of polyurethane backed floor covering products such as tiles, mats, roll goods, and the like produced on a single polyurethane range, wherein each such product includes at least 10% by weight recycled content, and/or wherein each such product includes at least 10% by weight post consumer recycled content.

In at least selected embodiments, a carpet tile includes a textile face structure disposed in overlying contacting relation to at least one layer of flexible, polyurethane backing composition, the polyurethane composition being the reaction product of
(i) a polyol component in which castor oil is the predominant reactive polyol (preferably greater than about 50% of the reactive polyol by weight or by reactivity, more preferably greater than about 60% of the reactive polyol by weight or by reactivity, and most preferably greater than about 75% of the reactive polyol by weight or by reactivity); and
(ii) an isocyanate component,
   and the polyurethane composition further comprising a filler, the filler being at least about 42% by weight of the polyurethane composition.

The carpet tile above, wherein the filler is selected from coal fly ash, recycled gypsum, recycled glass, and combinations thereof, wherein substantially the entire polyol component is unmodified castor oil (preferably greater than about 85% by weight of the entire polyol component, more preferably greater than about 95% by weight of the entire polyol component, and most preferably greater than about 99% by weight of the entire polyol component), wherein the polyurethane composition is substantially free of surfactant, wetting agent, or both (preferably less than about 3% by weight of the polyurethane composition, more preferably less than about 1% by weight of the polyurethane composition, and most preferably less than about 0.01% by weight of the polyurethane composition), wherein the polyurethane composition is substantially free of catalyst (preferably less than about 3% by weight of the polyurethane composition, more preferably less than about 1% by weight of the polyurethane composition, and most preferably less than about 0.01% by weight of the polyurethane composition), wherein said at least one layer of flexible, polyurethane backing composition is at least one of a precoat, tiecoat, backing, combined precoat/tiecoat, combined precoat/backing, combined tiecoat/backing, combined precoat/tiecoat/backing, and combinations thereof, further comprising at least one structural support layer disposed in, on, under, or over said layer of flexible, polyurethane backing composition, at least one backing layer may be disposed across the underside of said layer of flexible, polyurethane backing composition, or both, and/or wherein said textile face structure is at least one of tufted, bonded, woven, non-woven, needled, flocked, knit, and needle punched.

Although it may be preferred that the backing is a single layer combined precoat/backing or combined precoat/tiecoat on the back of greige goods, it is contemplated that in accordance with at least selected embodiments that each of the precoat, tiecoat and/or backing layers may be of the same or of different formulations, may be foam or nonfoam, may be filled or not filled, and/or the like. For example, the precoat may be a nonfoam, nonfilled formulation A, while the tiecoat is a nonfoam, filled formulation B, and the backing is a foam, filled formulation C. In another example, the combined precoat/tiecoat is a nonfoam, filled formulation D while the backing is a foam, filled formulation E. In yet another example, the combined precoat/tiecoat is a nonfoam, filled, castor oil polyol based polyurethane layer, while the backing is a foam, filled petroleum polyol based polyurethane layer.

It is contemplated that in accordance with at least selected embodiments that the filler for the precoat, tiecoat and/or backing may be recycled precoat, tiecoat, backing, face material, flooring product, or the like. It may be preferred to recycle the entire flooring product by grinding or densifying it and using it as filler in the precoat, tiecoat and/or backing.

While the present invention has been illustrated and described in relation to certain potentially preferred embodiments and practices, it is to be understood that the illustrated and described embodiments and practices are illustrative only and that the present invention includes such embodiments but is not limited thereto. Rather, it is fully contemplated that modifications and variations to the present invention will no doubt occur to those of skill in the art upon reading the above description and/or through practice of the invention. It is therefore intended that the present invention shall extend to all such modifications and variations as may incorporate the broad principles of the present invention within the full spirit and scope thereof.

1. A carpet tile comprising:
a textile face structure disposed in overlying contacting relation to at least one layer of flexible, polyurethane backing composition,
the polyurethane composition being the reaction product of
(i) a polyol component in which castor oil is the predominant reactive polyol; and
(ii) an isocyanate component,
and the polyurethane composition further comprising a filler, the filler being at least about 42% by weight of the polyurethane composition.

2. The carpet tile of claim 1, wherein the filler is selected from coal fly ash, recycled gypsum, recycled glass, and combinations thereof.

3. The carpet tile of claim 1, wherein substantially the entire polyol component is unmodified castor oil.

4. The carpet tile of claim 1, wherein the polyurethane composition is substantially free of surfactant, wetting agent, or both.

5. The carpet tile of claim 1, wherein the polyurethane composition is substantially free of catalyst.

6. The carpet tile of claim 1, wherein said at least one layer of flexible, polyurethane backing composition is at least one of a precoat, tiecoat, backing, combined precoat/tiecoat, combined precoat/backing, combined tiecoat/backing, combined precoat/tiecoat/backing, and combinations thereof.

7. The carpet tile of claim 1, further comprising at least one structural support layer disposed in, on, under, or over said layer of flexible, polyurethane backing composition, at least one backing layer may be disposed across the underside of said layer of flexible, polyurethane backing composition, or both.

8. The carpet tile of claim 1, wherein said textile face structure is at least one of tufted, bonded, woven, non-woven, needled, flocked, knit, and needle punched.

9. The carpet tile of claim 8, wherein said textile face structure is at least one of greige goods, backed, unbacked, precoated, and nonprecoated.

10. The carpet tile of claim 8, wherein said textile face structure is tufted greige goods and said at least one layer of flexible, polyurethane backing composition is a combined precoat/backing.

11. The carpet tile of claim 1, wherein the filer component is at least 50% by weight of the polyurethane composition.

12. The carpet tile of claim 1, further comprising a minor polyol component which is not castor oil.

13. The carpet tile of claim 12, wherein the minor polyol component is selected from the group consisting of natural polyols, petroleum based polyols, polyols with functionality of 2 or 3 and a molecular weight of about 750 to about 7500, PPG polyols, PEG polyols, PPG-PEG copolymer polyols, and combinations thereof.

14. The carpet tile of claim 12, wherein the minor polyol component is present in an amount of less than about 50% by weight of the polyol component of the polyurethane composition.

15. The carpet tile of claim 12, wherein the minor polyol component is present in an amount of less than about 10% by weight of the polyurethane composition.

16. The carpet tile of claim 12, wherein the minor polyol component is present in an amount of less than about 5% by weight of the polyurethane composition.

17. A polyurethane for application to a tufted, woven, non-woven, bonded, needled, flocked, needle punched, or knit textile face structure, including a polyol component, an isocyanate component, a catalyst and other agents, fillers, additives, and the like wherein the catalyst is eliminated, the polyol is replaced with castor oil, or both.

18. The polyurethane of claim 17, wherein the polyurethane forms at least one of a combined precoat/backing and combined precoat/tiecoat of at least one of a tile, rug, mat, and indoor/outdoor area rug.

19. A cured flexible polyurethane material, the polyurethane material being the reaction product of
(i) a polyol component in which castor oil is the predominant reactive polyol; and
(ii) an isocyanate component,
and the polyurethane material further comprising a filler, the filler being at least 42% by weight of the polyurethane material.

20. A cured flexible polyurethane material, the polyurethane material being the reaction product of
(i) a polyol component; and
(ii) an isocyanate component,
and the polyurethane material further comprising a filler, the filler being at least 42% by weight of the polyurethane material, and the cured flexible material being formed substantially in the absence of at least one of catalyst, surfactant, and wetting agent.

21. The polyurethane material of claim 20, wherein the polyol component is preferably a polyol component in which castor oil is the predominant reactive polyol.

22. The polyurethane material of claim 20, wherein the polyurethane material is used as a precoat, tiecoat, backing, or combinations thereof.
